(19) United States
(12) Patent Application Publication
(10) Pub. No.: US 2007/0106892 A1
(43) Pub. Date: May 10, 2007

(54) Method and system for establishing a communication using privacy enhancing techniques

(76) Inventor: Stephan J. Engberg, Lyngby (DK)

Correspondence Address: KLEIN, O'NEILL & SINGH, LLP, 43 CORPORATE PARK, SUITE 204, IRVINE, CA, 92606, US

(21) Appl. No.: 10/575,416

(22) PCT Filed: Oct. 8, 2004
(86) PCT No.: PCT/DK04/00692

§ 371 Date: Oct. 19, 2006

Related U.S. Application Data
(60) Provisional application No. 60/509,669, filed on Oct. 8, 2003.

(51) Int. Cl. H04L 9/00

(52) U.S. Cl. 713/168

(57) ABSTRACT

A method of establishing a communication path from a first legal entity in a data communication network comprises the steps of providing at least one private reference point comprised in the data communication network and establishing a communication path from the first legal entity to the private reference point. The method further comprises verifying the authentication of the first legal entity relative to the private reference point from the first legal entity and still further a method of establishing communication from the private reference point to a second legal entity through the data communication network without disclosing the identity of the first legal entity without disclosing the identity of the first legal entity.

### FIELD OF INVENTION

The elimination of Individual Information Security caused by technical change and sociological drivers in both the private and public sector is threatening the progress and stability of the Information Society. These problems are being pushed into the centre of discussions in all regions of the world without acceptable solutions.

One basic problem is the assumption that the core question is between anonymity or identification meaning either non-accountability of individual actions or growing dependency on trust and legal regulations to control abuse of identified personal data. The use of Pseudonyms with a Trusted party to prevent criminal abuse is even worse, because this leads to a concentration of either commercial or government power.

This invention comprises a series of closely related and integrated part-inventions that eliminate this assumption eliminating the trade-offs between accountability, freedom, convenience and efficiency. The outcome is the ability to enable free flow of personal data without risk of data abuse by ensuring that the individual remain in control through the basic principle of non-linkable accountability.

This invention solves the core problem of linking the physical world with the digital world with asymmetric linkability. The individual is enabled to link everything related to him, but even with free flow of information it is impossible for externals to link data to the specific individual beyond the explicitly created accountability principles that is created dynamically according to the specific application.

The core invention is implementing the Digital Privacy Highway based on anonymous one-time-only virtual Chip Cards or Privacy Reference Points (PRPs) combined with accountability negotiation and process support related to payments, credentials, delivery, storage, communication and the ability to re-establish contact anonymously. This includes a novel invention of anonymous credit and fully discardable Identity Cards even containing the basic passport, digital signature or international healthcare cards for emergency healthcare support.

These principles are extended to Privacy Device Authentication implementing untraceable Zero-knowledge Device authentication to protect against tracing devices, product tags or individuals in ambient computing. This invention provides a generic zero-knowledge solution to protect low-computation product tags such as RFID or Bluetooth tags from leaking information to the environment. Zero-knowledge product tags are both implemented as product tags attached to products or devices and as proximity tags attached to people or people transportation devices.

Numerous novel privacy solutions is demonstrated to everyday applications such as instant messaging, digital event support, trade support, managed CRM and SCM solutions, electronic voting, anti-counterfeiting money notes, device authentication etc.

### DESCRIPTION OF PRIOR ART

In electronic transactions protecting both digital and physical privacy is rapidly turning into one of the most significant problems of the Information Society. The escalating of identification and easy linking of Personally Identified or easily Identifiable Information (PII) is driving security risks and problems related to trust between the Client (Individual), the Provider (digital counterpart—whether commercial, government or social) and infrastructure (bank, telecom, shipping, portals, identity brokers etc.).

Smart cards (or chip cards) are devices able to cryptographic computations and securely storing data and Personally Identifiable Information (PII). State of the art Smart Cards are tamper-resistant in the meaning that they will ensure erasure of data in cases of attempt to access data by physically breaking into the smart card. This is essential to protect for instance access to the private parts of digital signature keys.

However except for completely anonymous or 100% card-based transaction solutions there are no solutions able to provide both privacy and convenience support across multiple transactions. Existing approaches to convenience are all based on non-privacy solutions where central trusted parties accumulate commercial control and abusable profiles on individuals.

### BACKGROUND

However even though smart cards promise the ability to reasonably ensure traceability against unauthorised access to PII using standard encryption with Digital Signatures such as Public Key Infrastructure, they prove unable to ensure confidentiality of PII in normal information processes from counterpart abuse.

For instance storing PII on the smart card only to be provided at point of use will not prevent the counterpart storing data and building databases linking PII across multiple transactions and across different counterparts. Smart cards are subject to theft. The consequence is that the data owner no longer is able to use the information. Even if NO data were collected at point of use, this would be leaving security to the quality of tamper-resistance.

Rather than real security, approaches based on PII are based on trust, legal protection towards counterparts, and subject to massive problems related to the balance between security, privacy and convenience.

One approach to reduce this problem is for a trusted third party to issue for instance one-time-only cards for internet credit card transactions. Even though these models reduce the decentralised risk, they accumulate central risk and do little to provide real security. Since they link across transactions and counterparts these central databases is an even larger security risk as they are able to create detailed profiles on individuals with no inherent security.

An example of such a central approach is U.S. patent application 20010044785 included here by reference discussing many of the general issues related to mail-order commercial transactions. A central server issues proxy names, email and shipping information to prevent merchant databases from cross-linking. The central server acts as a trusted part knowing the real identity of the end-user.

When using a smart card as a cash card using limited show keys as digital cash (Chaum patent ref. WO0208865) or credentials (Brands U.S. 5604805) and avoiding the use of any persistent identifier (whether person, card or device related) across transactions, the smart card is able to support anonymous payments or anonymous attribute authentication.

However for multiple applications this approach does not provide a suitable solution and therefore this type of cash card has only limited success. Purely anonymous transactions do little in terms of enabling convenience requirements. Another serious problem is integrating support for these schemes requiring advanced infrastructure support to work.

Storing all data in a on the smart card and having the data owner only presenting non-identifying information on use will not solve the problem.

The basic problem is that most applications will require agent-support from an increasingly intelligent infrastructure such as establishing credit in payments, communicate, negotiate or just providing real-time access to profile information that is not stored on the card. But doing this is not solved without the use of persistent identifiers related to devices such as card numbers or MAC-addresses or the person such as Social Security Numbers or the public part of a Digital Signature.

State of the art in smart card and PKI technology is that there are little or no solutions as to avoid information from daily transactions being collected in databases in ways that are easily traceable to the real identity of the holder of the smart card. Privacy issues can be a blocking factor for the entire Information Society (http://www.eeurope-smartcards.org/Download/04-1.PDF).

State of the art in Digital Rights Management Systems such as U.S. Pat. No. 6,330,670 included here by reference is based on systems that create external linkability to devices or identities. These solutions in addition provide direct addressability of devices and provide the ability to restrict the end-user beyond the interest of Digital Rights Protection. For instance external control of the root CPU can provide the ability to implement restrictions on running software or listening to music from other providers. This can even be implemented later as an element of a forced software update.

Present state-of-the-art in Digital Rights Management System (or Trusted Computing) has not solved the basic problem, because the end-user or end-user devices are externally traceable and the end-user does not have device control. The consequence is that Trusted Computing is threatening to destroy both trust end security.

The patent application, “A method and System for establishing a Privacy Communication path”, ref. WO0190968, included hereby reference by the same inventor provide a solution to Digital Rights Management Systems tracing mobile phones or other communication devices. This is done through a chip card implementing multiple context-specific and infrastructure supported identities in order to hide the actual device identity from software running in the device.

The same patent provides several solutions on how to privacy-enhance and secure standard payment card transactions. One security solution is cross-authentication using a second communication channel such as a mobile phone. A privacy measure is a crowd-effect reusing the same credit card across a larger group of people with the same inline cross-authentication using a second communication channel. For online payments the use of one-time-only card references towards a trusted party separating the transaction from the bank payment system.

The same patent application also provide general solutions to strong privacy solutions using smart cards in trusted mobile devices (Privacy Authentication Device) such as Mobile phones, PDAs, portable computers etc. In this solution the context-specific credit card reference is closely linked to a context-specific pseudonym using a Privacy Authentication Device to establish the ability to communicate, trade and enter into legally binding transactions. Herein the Privacy Authentication Device is assumed to either authenticate directly storing multiple keys or establish encrypted non-identified tunnel connections to one of several home bases using reverse authenticates to protect against device trace.

Using the present invention this approach is fully extended to meet the full set of requirements for a dynamic pervasive environment such as creating new anonymous connections over an open network, integrate flexible linkability, dynamic group support, integrating low resource devices such as RFID, create built-in protections and instant revocability of chip cards storing digital keys in case of device theft, and the ability solve some of the vital problems related to Trusted Computing without preventing Digital rights Management etc.

Through Privacy Enhancing Technologies these problems related to security and trust concerning PII is solved or at least significantly improved technically.

Invention:

This Invention relates to privacy-enhancing convenience and security in digital transactions and the problem of creating a secure and privacy-enhanced infrastructure for multi-application chip cards even in untrusted environments.

This invention solve the problem on how end-users is enabled to enter into anonymous transactions and still collect detailed transaction data such as digital invoices or warranties for personal use and decide precisely how much information linkability is created for the service or product supplier.

This invention solves the problem of instant revocation of PKI-type Digital Signatures and protecting chip cards from theft by ensuring no abusable information is stored on the chip card that cannot easily be revoked and the chip card fully discarded.

This invention solves the technical barrier to implementation of Privacy Enhancing Technologies by implementing revocable privacy-enabled digital cash, credentials and digital signatures as managed services. Further this invention solves the problem of how to provide anonymous credit.

This invention solves the problem of how to Privacy and security enhance Trusted Computing by creating multiple anonymous digital keys traceable to hardware specifications for external verification that a specific key is controlled by hardware under certain conditions without knowing which device is controlling the key.

This invention provides the flexible means for the individual to control the level of linkability of transactions towards the counterpart without limiting convenience or privacy. The smart card will for each transaction issue a unique transaction code and an authentication mechanism which he control using a fully anonymous pseudonym operating through a mixnet.

This invention create solves the problem of trust-linking devices in the home or other domain without wiretapping can identify which devices are communicating. In addition this invention creates a generic solution as to how devices can communicate using a virtual device identity to eliminate linkability across transactions with the same device.

This invention solves the problem of how to create and negotiate accountability paths for anonymous transactions dynamically adapted to context risk profile without creating linkability. An action of an individual is accountable without making multiple actions of individuals linkable. No single trusted party is able to link the identity of an individual to an action. Multiple different principles can be incorporated in the accountability path such as specific accountability incorporated through limited-show credentials, time locks, milestone verification, serialised/parallelised trusted party identity escrow etc. Manu of these can be built-into tamper-resistant and verifiable hardware eliminating the need to trust an organisation or human.

According to another embodiment this eliminates the use of active trusted parties. The Client can through traceability to hardware-specification verify a certain proof applies to certain criteria such as an escrowed identity encrypted with third party controlled keys without requiring trust on behalf of the third party to verify this.

Further this invention solves the problem of how to privacy-enable RFID or other product identifiers or product controlling devices. By implementing a zero-knowledge authentication process initiated at point-of-purchase the seller or initial producer is able to transfer control to the buyer without others being able to track the product or identity of the owner by traffic analysis or wiretapping wireless or other communication. This invention is easily extendable to implement privacy-enhanced digital keys in all sorts of products or devices.

This invention solves the problem of how to create security and privacy enhanced authenticity or third-party product certification without creating linkability.

Several transaction principles are supported with the same invention ranging from anonymous to pseudonymous with standard credit card payments, electronic cash or credit payments combined with pseudonymous convenience and a privacy enhanced and strong security solution for debit or credit cards payments in Chip Cards in un-trusted environments, i.e. using a foreign chip card reader.

In environments where the only available communication path is an electronic chip card reader provided by the counterpart such as a merchant, problem of how to conduct transactions without leaving identifying information are significant. This is what we call un-trusted environment since both the counterpart and the infrastructure provider is assumed to prefer identification and thereby depriving the individual of control of PII.

The invention provides a solution as to the use of more sophisticated Privacy Enhancing Technologies even if the Provider is not equipped for this. The smart card communicates with a service provider which translates the advanced and sophisticated PET technologies like Digital Cash, Credentials etc. into more simple standards such as credit card protocols or verified Client profiles.

In addition the invention provides the solution to a series of core problems related to the balance between convenience and Privacy including Anonymous Credit and infrastructure support of multi-application privacy enhanced smart cards.

This invention solves the problem of simultaneous privacy, security and convenience in Chip Cards used in un-trusted environments defined as foreign chip card reader. The communication between the chip card and the chip card reader is based on physical connection enabling the IP-protocol or any wireless communication standard such as WLAN, Bluetooth, infrared etc.

The invention solves the problem of a Client connecting multiple transactions using the same card across multiple providers and retaining full control over the level of linkability by both Providers and Infrastructure.

This invention solves the problem of how to create tickets or other services without linking across multiple transactions enabled by the same device.

### DISCLOSURE OF THE INVENTION

This invention is based on two key inventions.

Firstly the means to turn a physical chip card into multiple virtual and non-linkable chip cards by use of one-time-only Privacy References (PRPs) replacing Persistent Card identifiers such as for instance credit card number. This is combined with means to later reconnect to the transaction through a non-identifying communication network. By inserting these Cards into fixed, wireless or mobile Card Readers, the Client is provided with the means to intelligently manage multiple virtual identities and receive personalised services while still retaining control of the ability of others to link personal data to the real identity of Client.

Secondly the means for Clients to take control of electronic product communication devices (EPC-Devices) such as RFID, Bluetooth or more advanced devices using a principle of zero-knowledge authentication. EPC-Devices simply will not respond or acknowledge their existence unless properly authenticated.

EPC-devices is linked to a product or service such as for instance an RFID sewn into a shirt. They can also be tightly integrated and providing advanced controls such as for instance a digital car key directly linked to the petrol injection and customised settings or a house alarm linked to the home communication infrastructure resetting communication preferences of the individual to the home environment.

Together these inventions make it possible for individuals to control their digital environment without risk of leaving identified personal data in databases usable for privacy violations.

### DESCRIPTION OF FIGURES

FIG. 1 illustrates the basic invention of creating and re-linking virtual chip cards

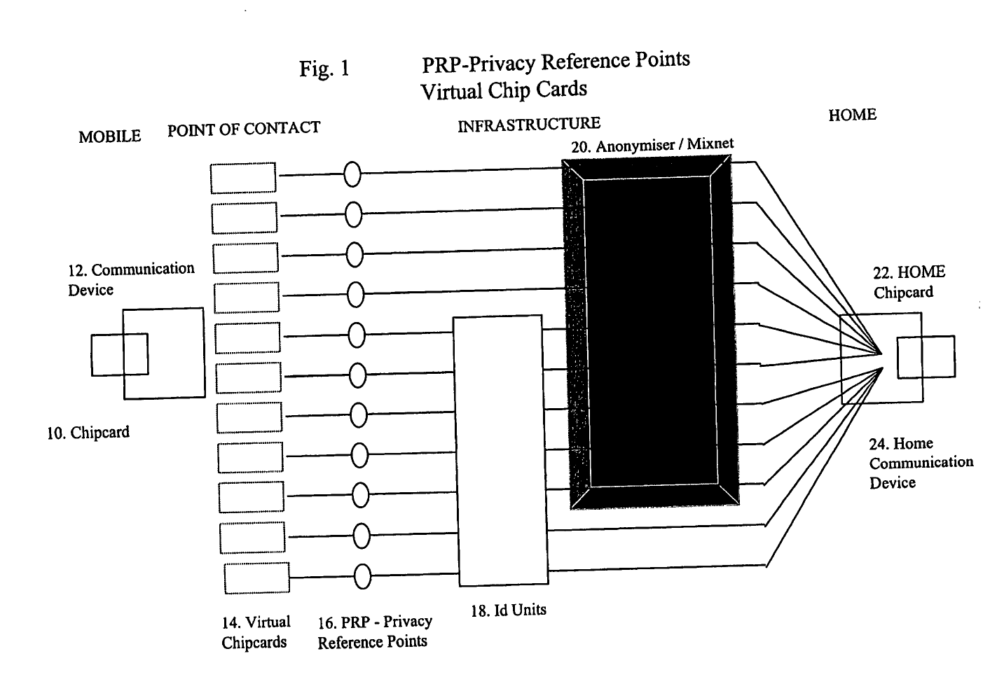

FIG. 2 illustrates the linking between the product life cycle in the commercial value chain and how the product transfer to consumer privacy control and then eventually re-enter the product life cycle for recycling of materials etc.

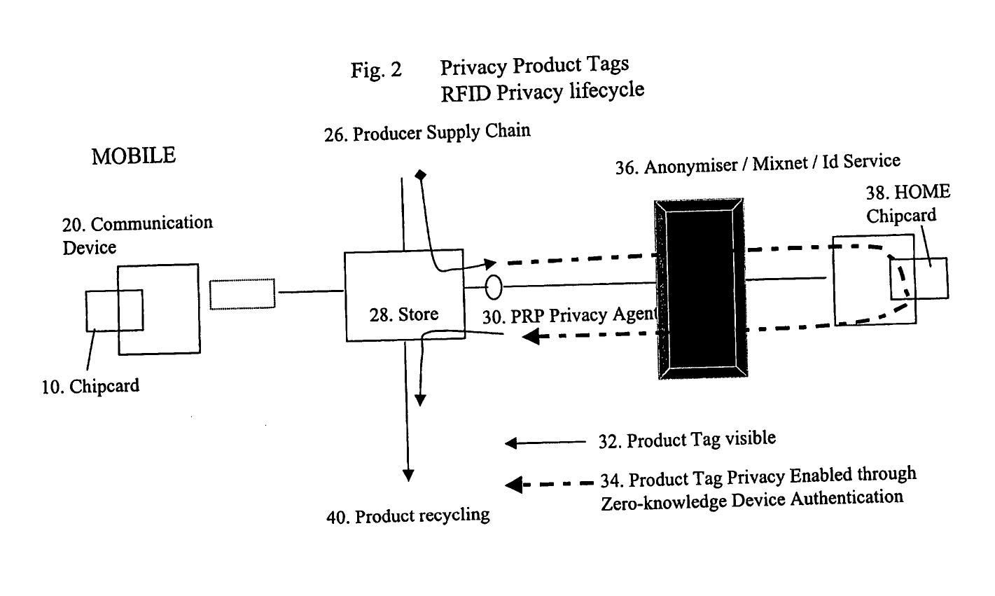

FIG. 3 illustrates the basic infrastructure for privacy chip cards

FIG. 4 illustrates the creation of a pseudonymous basic relationship

FIG. 5 illustrates privacy-managed payment and credential support

FIG. 6 illustrates the preferred solution for anonymous credit

FIG. 7 illustrates how to include untraceable accountability for pseudonymous relationships

FIG. 8 illustrates how the to privacy-enable standard credit-card payments

FIG. 9 illustrates how the solution is extended in one embodiment by direct management of personal identities using wireless or other personal communication devices

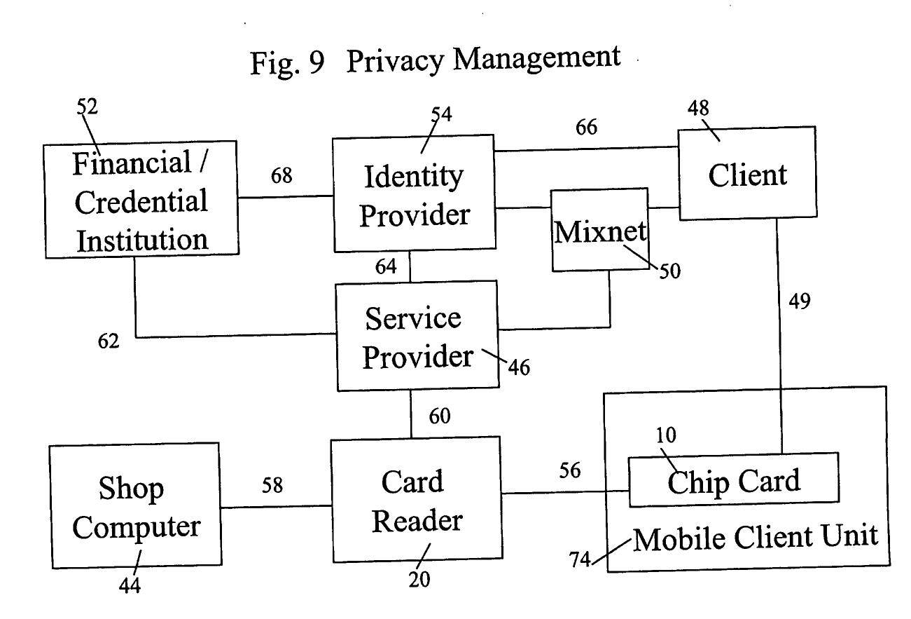

FIG. 10 illustrates the device authentication according to the present invention

FIG. 11 illustrates privacy-managed digital signatures with instant revocability

FIG. 12 illustrates the basic infrastructure per privacy-enabled RFID using untrusted RFID and chip card readers

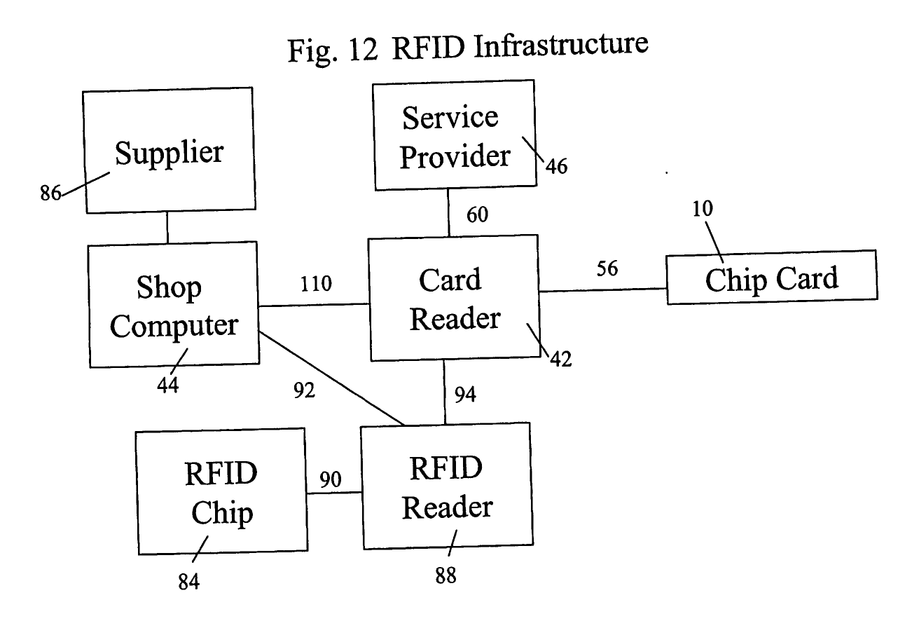

FIG. 13 illustrates the use of mobile devices for controlling RFIDs using untrusted RFID and chip card readers

FIG. 14 illustrates how to create a Privacy Proximity Ticket using a combination of Group Authentication and PRPs

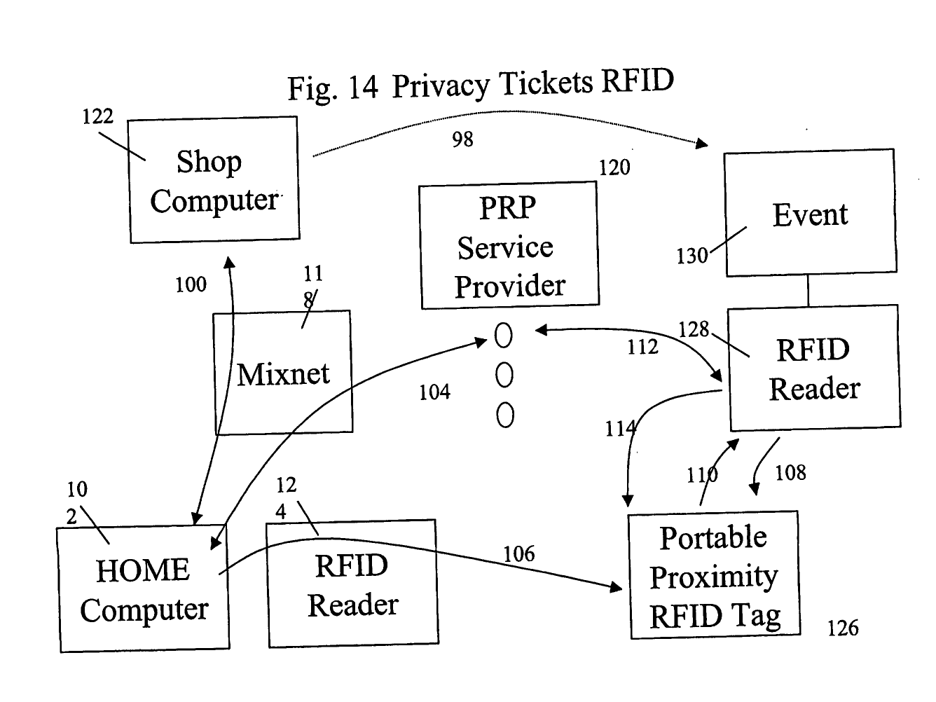

FIG. 15 illustrates how to create connections between anonymous sessions

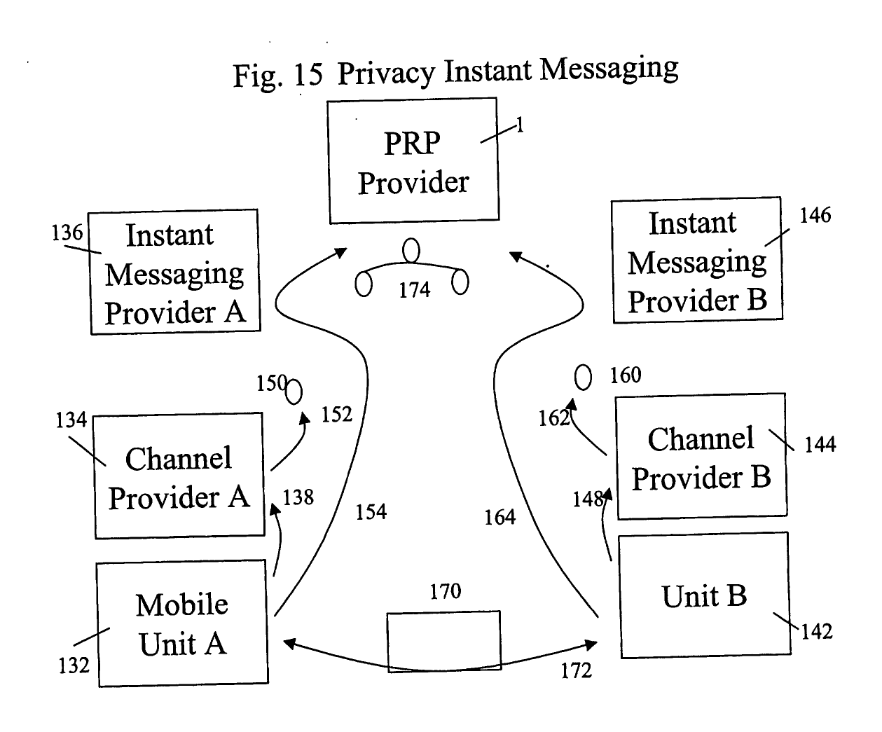

FIG. 16 illustrates a zero-knowledge authentication process including group authentication and device authentication, and

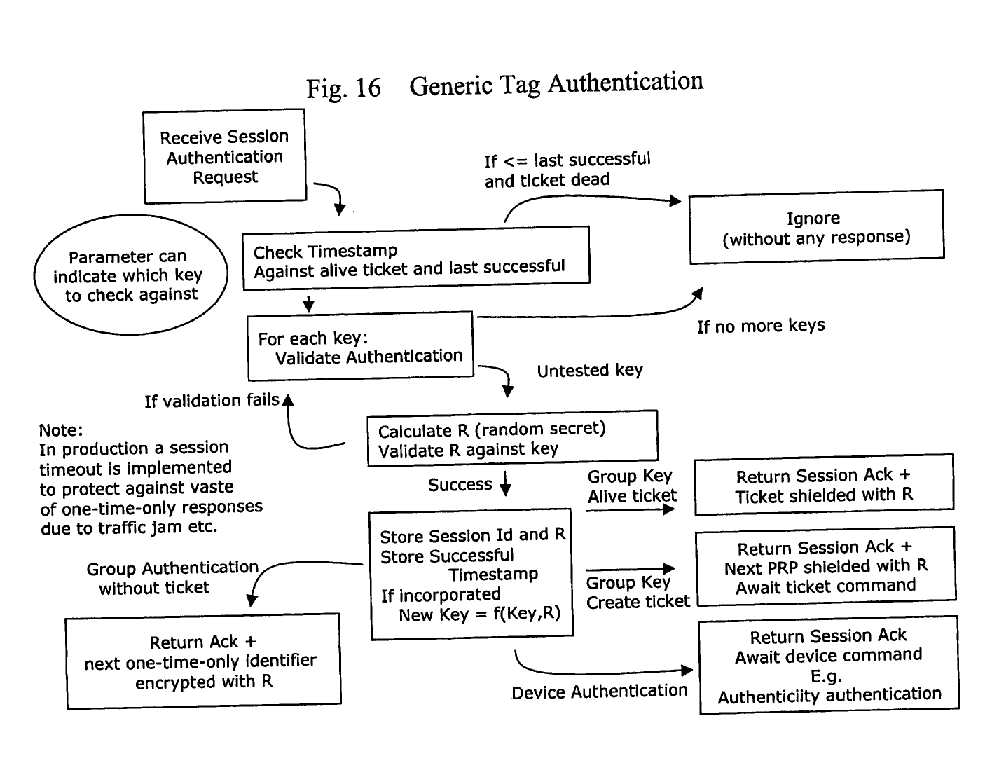

FIG. 17 illustrates a mobile device able to directly control the personal space.

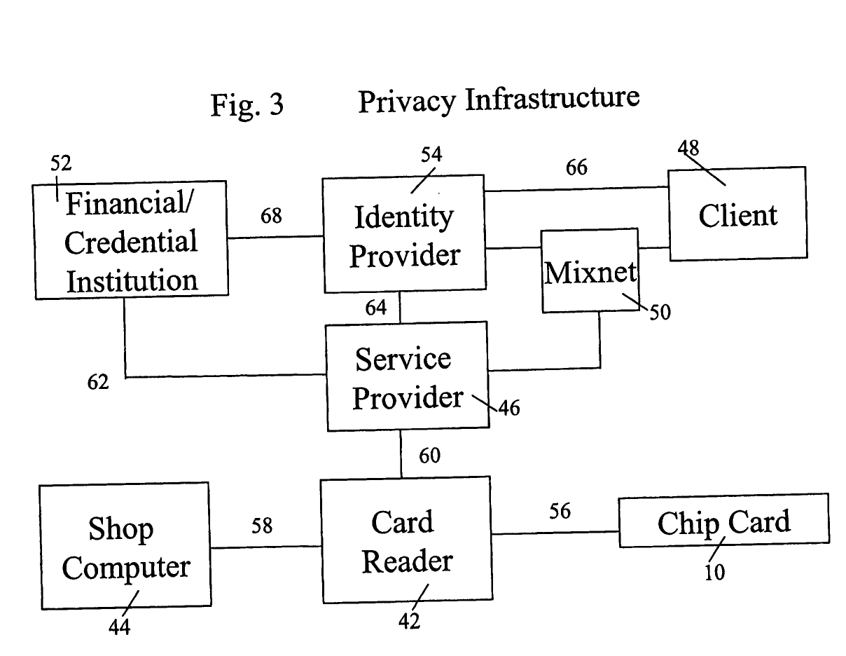

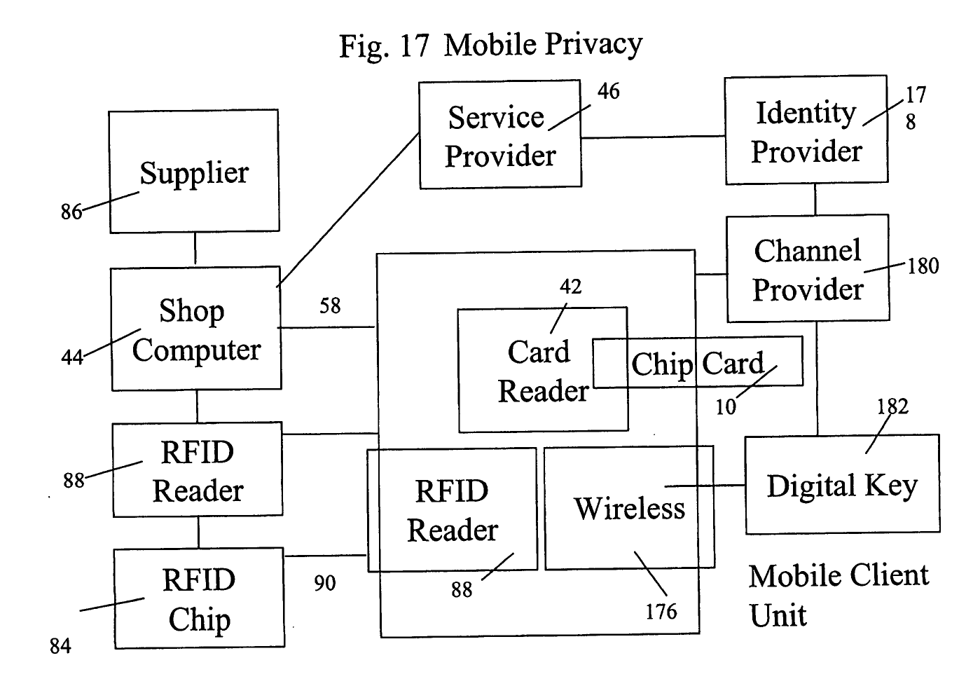

FIG. 3 shows the preferred setup for multi-application chip card infrastructure. The Chip Card (10) is communicating one-time only References to the Card Reader (42) using the communication channel (56) over an fixednet IP-connection or any compatible open protocol such as a wireless channel. The Card Reader provides the connection to the Shop Computer (44) or in another embodiment done directly using for instance wireless communication protocols. The one-time only Reference is forwarded to the Service Provider (46) together with instructions encrypted inside the Chip Card. Client connect from his Client base (48) to take control of the transaction without revealing his real identity through a mixnet or other anonymising network (50) or an Identity Provider/pseudonymising unit (54) through any communication channel (66). Depending on the encrypted instructions, the Service Provider (46) can verify anonymous payment or credential mechanisms directly (62) with financial institutions (52), or indirectly acting as a Trusted Party by forwarding chip card encrypted instructions to the Identity Provider (54).

A standard so-called EMV-chip card payment can be emulated so that the Shop Computer (44) and Card Reader (42) does not have to alter their systems, but still the Financial Institution (52) see the shop as either the Identity Provider (54) in case of standard credit payments or Service Provider (46) for anonymous payments. The Service Provider gets payment confirmation either directly or through the Identity Provider and can therefore verify payment towards the Shop Computer (44).

Key to the advantage of setup is that the Service Provider and the Shop not separate two transactions with the same chip card from two transactions with two separate chip cards unless Client wants it so.

If the encrypted instruction to the Service Provider (46) contains a data reference derived from a Shop Identifier, Client has an option to instruct the Service Provider to link the transaction with previous transactions with the same Shop for Client convenience. In addition the Service Provider is optionally instructed to report this link back to the Shop as part of the transaction and thereby enabling the Shop to create anonymous customer profiles or turning the Chip Card into Shop Loyalty card.

Client can maintain two-way communication with the Shop (44) through the service Provider (46) without ever revealing his true Identity.

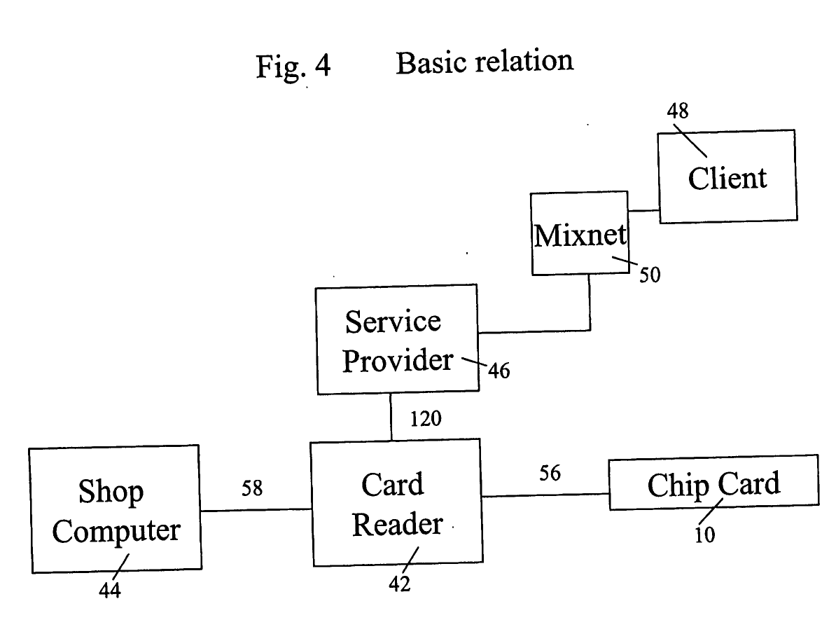

Basic relationship FIG. 4 illustrates the most basic usage and generic use of this invention. By entering the Chip Card in a reader, Client creates a simple communication channel for the Shop to communicate with Client through the Service Provider (46). In addition to a One-time only Reference, the Chip Card must initiate an authentication mechanism for Client to prove ownership of the Relationship and optionally share an encryption key with the Shop to ensure that the Service Provider cannot read communication. In addition the Chip Card will encrypt Shop information for Client use upon re-connecting from the Client Base (48). The Client Base is assumed to be a Trusted Device such as a portable computer, a PDA, a mobile phone or any computer at work or at home, but can be any device able to communicate and do the computation—even a Chip Card.

The Shop can use the One-time Only Reference as an address towards the Service Provider who then either store the message until collected by Client (Pull) or use pre-prepared Mixnet Reply-blocks to forward the message to Client (Push) without the Service Provider being able to identify Client. By mapping the reply-block to the SIP-Session initiation Protocol, this principle is able to seamlessly support most standard communication channel.

The context when establishing this relationship determines the use. This include subscribing to a news list, providing role-based contact information, answering detailed questionnaires to participate in any scheme without risk of data leakage and use outside of the specific context.

A key issue is that the protection of Client Identification can be made strong enough to get acceptance from data protection authorities to the relationship setup considered anonymous in the context of Data Protection laws and still incorporating accountability. If so data registration are not requiring permission in the legal definition since Client is in Control of customer profile data. This would also vastly reduce the problems related to anti-crime data retention since data stored at the ISP would be secured.

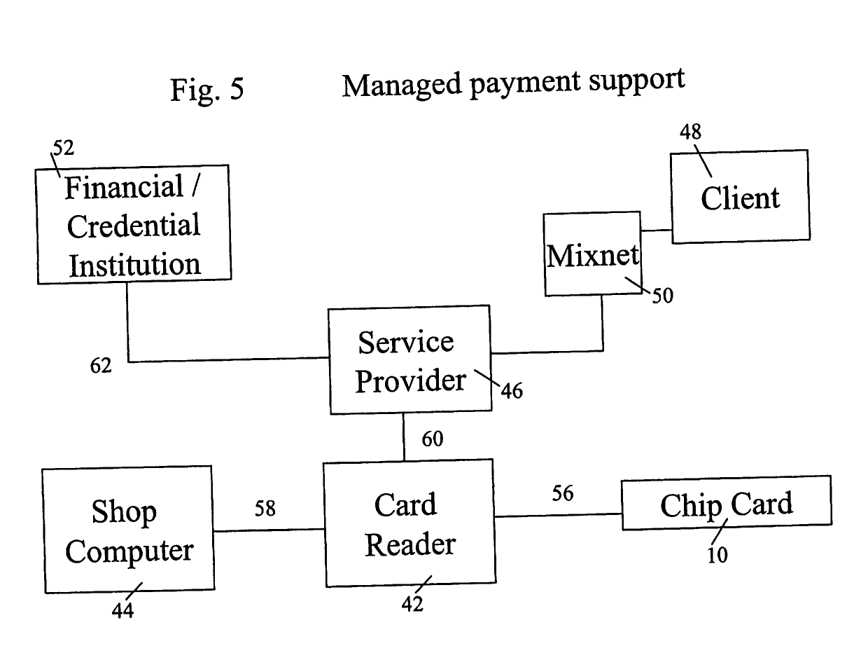

FIG. 5 takes a step further and enable support for Managed Services of Digital Cash or Digital Credentials, even if the Shop is not equipped to handle these technologies. The Shop Computer (44) forward payment instructions including Ship Id, Amount, Transaction Id, Date and optionally a digital invoice to the Chip Card Reader and terminal (42). The Card Reader can assume the Chip Card (10) is a standard Chip Card emulating standard credit cards interfaces. This can be either direct contact or wireless communication (56). The Chip Card emulates a standard interface by using a One-time Only Reference or reuse the same Chip Card Id depending on the standard. The Chip Card then interacts with Client through the Card Reader interface for instance using a multi-pin setup and chooses action according to Client Instructions.

For an ordinary payment the Chip Card pay to the Service Provider (46) using Digital Cash encrypting the message to the Service Provider and forwarding this encrypted message containing the Digital Cash Show protocol through the Card Reader to the Service Provider. The Service Provider finalise the Digital Cash transaction with the relevant Financial Institution (52) over any communication channel such as a fixed VPN internet connection for large-volume transactions. Upon clearance from the Financial Institution the Service Provider acknowledges payment vs. the Shop according to the payment interface standard.

At this point the Service provider provide transaction services such as managing sales taxes, fees, VAT and special problems related to for instance cross-border transactions.

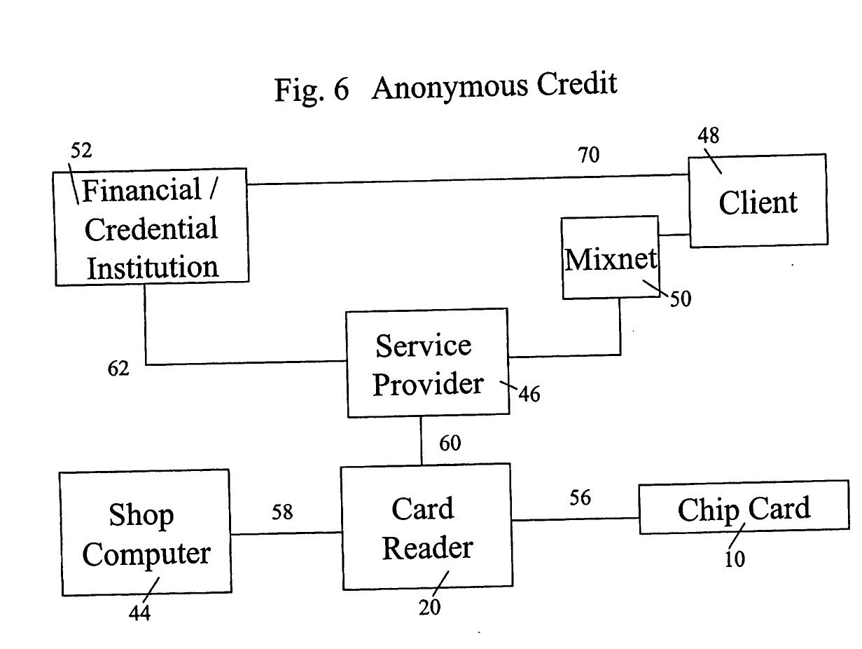

A special variant of the payment scheme in FIG. 5 is illustrated in FIG. 6. If Client prior to the transaction has established a credit line with a Financial Institution (52) which is then translated into Digital Credential Tokens stored in the Chip Card (10), this setup is able to establish anonymous credit. If a sufficient large group of Clients use these Anonymous Credits and create a crowd effect, the Financial Institution cannot determine what a specific credit was used to purchase. However, they know on a group basis and thereby is able to make various partner agreements between financial institutions and shop possible.

In the preferred setup the Financial Institution (52) issue Credit tokens on a rollover basis with overlap meaning that there will be an issue period (of say 3 months). When the rollover period ends, Client cash in unused tokens and receive new ones. Used tokens are transformed into a loan. When Client use credit tokens to pay, it works like Anonymous Digital Cash or Digital Credentials since the Financial Institution (52) is able to determine that the specific credit token is issued by a specific financial institution or group of institution and thereby honour the payment claim. To compensate for differences in purchase dates in the issue period, interest from time of purchase to the rollover date is deducted from the amount.

If the Client group is sufficiently large for a specific pool of credit tokens, loans can even be established on a daily basis selling bonds directly in the financial markets. This is based on a pro rate risk using Client loans as security or with the Financial Institution guaranteeing the bonds and applying a risk premium on Client loans. This translates into a situation in which Client is enabled to anonymously buy a sofa with instant credit using financial market interest rates and using the surplus asset value of his house as collateral.

The various parts of the invention

Privacy Reference Points

One important aspect of this invention is the ability to establish anonymous connections between the offline world and the online world. These are called Privacy Reference Point (PRP) which are virtual addresses based on a domain offset link and a relative reference (<domain>Ref for instance http://www.PRPRef.NET/Ref# where Ref# is any combination of characters, numbers etc.).

Whenever a transaction is initiated a PRP is provided by the Chip Card as the transaction specific identifier or one-time-only card number. Except for this identifier the Chip Card will leave NO additional identifiers unless voluntary approved by the Client as part of the transaction.

In case of PRPs provided by a RFID-tag as an RFID pseudonym from a list of pseudonyms (such as a ticket) etc. the PRP store pre-encrypted information that upon forwarding to the Service Provider authorise release of data to the provider of services.

PRPs provide an anonymous way to block for the Chip Card in case of theft and asymmetric linkability for enabling convenience and services.

If the Chip Card attempts to establish an anonymous session, the Client is enabled to deposit a message to the Chip Card that it is stolen without creating linkability. The Chip Card then act accordingly by deleting all content or assist in tracking the thief.

A PRP provide the ability for the Client later to establish connection with the transaction without having to store information in the portable device. In addition it is able to create a communication link to the Client if Client has established an open communication channel to the PRP.

On Security in Case of Loss of the Smart Card.

It should not be possible to extract the keys to generate the one-time-only identifiers. Meaning there should be NO way for an attacker to be able to generate the historic identifiers of user transactions and thereby assume control of or link transactions.

Unencrypted Export function of the keys themselves should not be possible. Instead one solution is to work with one-time-only export of the one-time-only identifiers (and related authentication keys) to a secure client environment (likely home) from where the owner establish connections to his transactions through an identity-protecting communications network.

Anonymous Credit

In many circumstances credit payments is needed which is today covered by use of credit cards. Even though anonymous cash using Limited Show Keys is known, paying anonymously with credit without the Provider or the Bank linking the purchase to the real identity of client is not possible with present knowledge. This invention solves this problem using a combination of roll-over lines of credit and a token-based credit system which towards a Provider are similar to undeniable digital cash drawn on a Financial Institution but to the Client is a drawing right on a pre-approved line of credit. The main properties works similar to anonymous Digital Cash, but the way the tokens are issued will result in a loan from the Financial Institution to the Client.

The preferred setup works by a financial institution applying a line of credit to Client. Normally the Client is identified towards the bank to establish credit. But the Client can also be pseudonymous to the bank itself—treated as a special case after the main setup.

This line of credit is on a periodically revolving basis transformed into Coins (tokens) using Digital Cash Technology, which is limited show keys according to David Chaum or Stefan Brands.

In order to pay with credit, Client will spend his tokens in ordinary shopping as Digital Cash. Whenever the financial institution is presented with the use of a token it will honour it with a pre-defined amount in cash transfer. The Merchant will receive cash and do not have to know that this is a credit payment.

At the end of each Period the Client return unused Coins to the Financial Institution and get new ones. Client cannot return used Coins without self-incriminating him as multiple use of the same Coin will provide the bank with the ability to prove abuse similar to the protection related to multiple use of Digital Cash with disclosure of a self-signed confession and identification.

The difference between Coins issued and Coins returned equal the amount borrowed which is then treated as a withdrawal related to the line of credit. If multiple Clients use the same type of Coins for the same periods, the bank has no way to tell which Client made a specific payment.

Theft protection is built in, if Client either store a copy of the Coins or when receiving new Coins technically create an offline payment for himself using all the Coins. Using this backup protection, the Coins in case of theft is forwarded to the bank. When the thief try to use the Coins for payments, the bank detect this and block payment in real-time.

When using a Coin for payments the bank deducts interest until the next roll-over date of the line of credit in order to make the withdrawal start according to the use.

The bank needs to be able to terminate the credit line, if for some reason the line of credit has been reduced or terminated. The use of periodically revolving provide both an ability for the bank to change the terms of the line of credit and the way to convert use into loans on a regular basis.

Outstanding credit Coins has to be honoured for the duration of the period unless Client returns unused Coin in mid-period. Periods should preferably be overlapping in order to prevent end-of-month crowd effects.

Use of tokens with associated attributes provides the ability to support for instance special discount agreements with merchant.

When using a intermediary to carry out the interaction with the bank, then the bank does not need to know the identity of the Provider thereby further reducing the risk of collusion detection on behalf of the bank.

Pseudonymous line of credit approval is possible based on attribute credentials in combination with Privacy accountability which is a multi-step re-identification process in case of violation.

Pseudonymous credit approval can for instance be arranged in the following way. Many countries have central registers of Bad Credit Risks including people and entities having failed to honour a financial obligation or an outstanding debt. Using Attribute Credentials (Stefan Brands U.S. 5604805) a Client desiring credit receives a one-time-only attribute credential issued by the Bad Credit Risk Agency that he is NOT on the list. When presenting this credential to the Financial Institution, an optimistic line of credit based on the knowledge of previous non-default can be issued.

The Financial Institution is similar able to issue a credential that the line of credit is terminated and all loans paid in full. If the setup works with a standard maximum amount, the attribute credentials can further be denominated into smaller lines of credit by issuing a Credential with each use

This would most likely be on smaller amounts, but the Financial Institution can build the credit risk into the interest required thereby creating pools of higher-risk loans.

Establishing Privacy-Enhanced General Accountability

In some occasions payment risk is not the only risk included. For instance renting a car or hiring an internet connection might include criminal activity. A better alternative than requiring identification and data retention is to establish a way to identify that only lead to identification if wrongdoing is determined. This is known as Identity Escrow.

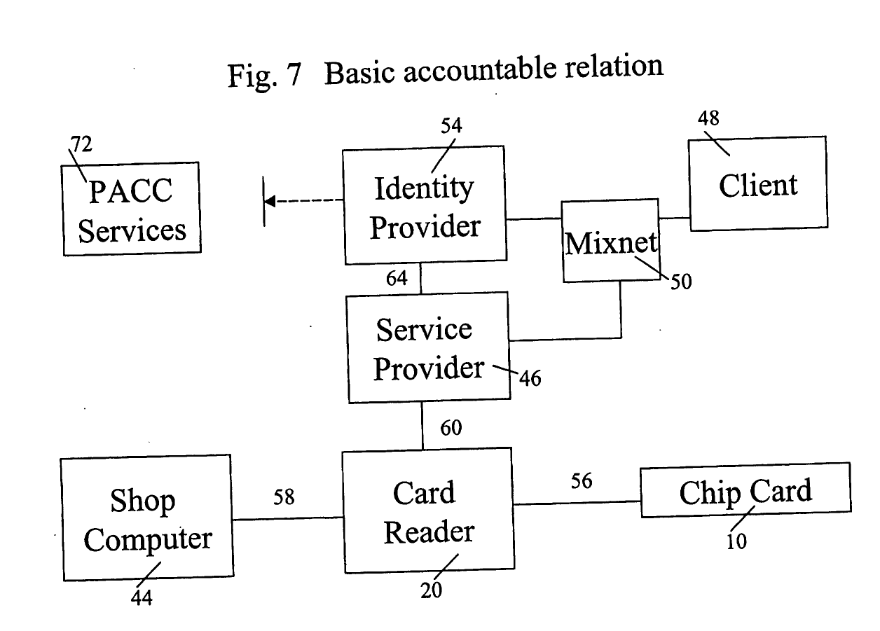

FIG. 7 describes such a solution in which the message to the Service provider (46) contains instructions to forward an encrypted message to an Identity provider (54) linking to a pseudonym with an attached encrypted message certified by third-party to contain identifying information of said pseudonym and instructions as to the first step of a process to decrypt the message incorporating at least one third-party not involved in the transaction at any step.

Multiple different accountability procedures can be designed balancing the cost and difficulty of identification with the potential fraud value of Client and the democratic principle value of the activity. For instance the control to return a book to a library or for general surfing at news sites or discussion forum should be strongly protected whereas the voluntary entering into a credit arrangement likely should only have a simple trusted party included the in the identity disclosure process.

A key issue is that the question of accountability does not make sense if anyone can commit identity theft and thereby transfer the responsibility to others. This include on one side identity theft of a pseudonym through which ownership of an asset or obligation of a liability is established and on the other side the ability to identity theft of the base identification which provide the fundamental accountability.

In other words accountability is dependant on unbroken traceability of an action to a unique identity. In the physical world this is based on witnesses, pictures, signatures etc. In the digital world the technical cryptographic traceability and especially the links to the physical world depends on fewer proofs and the potential crimes large in both size and variations bigger in number and potential magnitude, the traces has to be stronger and unbroken.

Basic Device Security and Ownership—Privacy Biometrics Authentication

For reasons of both protection against Identity theft and protection of personal data in case of the device theft, authentication of the Client towards the device itself is necessary. Pin code, passwords, crypto boxes etc. only provide proof of knowledge or physical access, but it not a real proof of Identity. To achieve proof of identity, biometrics is the best way to improve security. To avoid central storage of biometrics or biometrics leakage in case of theft, it is important that only a one-way encoded version of the biometrics template is stored. In addition this should be done using a Chip Card specific encoding.

In the following we assume the basic security is a combination of both a one-way encoding using a Card specific encoding. This could for instance be a one-way low-collusion hash of a card specific key XOR'ed with a one-way hash of the biometrics template or minimum equivalent security. In addition this is assumed to be COMBINED with pin codes, passwords etc. including silent alarm such to decrease the likelihood of successful authentication by others than the right Client without voluntary collaboration.

Special attention is to be put on so-called identity or credential lending as basic security often ignore this problem and leave it to crime investigation. An example is “loosing” a credit card combined with subsequently denying payments or a more advanced example of swapping credentials between a paedophile and a drug addict to mutual advantage.

Accountability Negotiation

This makes possible to create privacy accountability profiles (PACC) describing the accountability level of the PACC that a session is authenticated towards. An Accountability Profile would in a standardised way describe if, under what circumstances and how escrowed identity can be released.

PACC parameters can include the type of base identification (biometrics etc.), the legal domain (for instance country or court), amount limits, time limits, category of trusted parties, special conditions etc. These can be technically designed into the

The preferred solution for generic application where it is impossible to determine the application risk in case of abuse such as surfing the internet is at least a two-step process based on a double encrypted identification of which the outer layer is encrypted with the public key of an asymmetric key pair related to the court that should determine the justification of identification and an inner encryption layer encrypted with the public key of an asymmetric key pair related to a pre-approved entity verifying the court procedure.

This verification entity can be external to the country and should operate a procedure that gradually makes access to decryption keys more difficult as time passes. For instance by encrypting the private decryption key with the public key of yet another entity, thus increasing the whistle blowing mechanism in case of attempts of mass-surveillance or forced access or decryption keys.

Period-specific public keys can be published by any number of trusted parties meaning that the corresponding private key will be deleted within a pre-defined timeframe preferable in some verifiable manor using for instance verified hardware to store the keys. Since public keys are published a trusted party does not know what kind of secrets is guarded and for whom.

This invention further contains descriptions on how to establish PACC using privacy enhancing Trusted Hardware where it is possible for externals to verify that a PACC adhere to certain specification without any trusted party having to be involved to verify and certify correctness.

The core link to the physical world will have to lead back to the basic Identification which sets the limit to accountability. Creating this link between the physical world and digital world is in the end a form of biometrics combined with a link certificate from some entity that has to be trusted. This issue and especially the link to DNA-registration is described in more details in the patent application ref U.S. 20030158960 “Establishing a privacy communication path” which is included here by reference.

Life Linkability

The main purpose of this invention is to implement the concept of non-linkable accountability, i.e. ensure that accountability is established with the least possible linkability across transactions so that even if one transaction is made traceable to the individual, other transactions by the same individual are close to impossible to locate.

However this balance is a political decision. If it is politically decided each step in the creation of a PACC can be accompanied with a parallel step creating reverse linkability so that a series of pre-programmed steps can create a link from an identified entity to the virtual identities. If all these are stored in an accessible manor full life linkability can be created.

One situation where this could be decided would be for convicted criminals—perhaps of certain types of crimes or certain duration of penalties—that they loose the right for non-linkability. This setup could be implemented using either positive or negative credentials. For instance, if the person cannot present a period-specific citizen credential, the part creating the PACC-steps will also create the reverse entity.

Creating these data components are significant more sensitive than the PACC since individuals can be totally targeted after any action has lead to identify the person.

Features like these would in a preferred implementation only be included on a selective basis and not as part of the default PACC process.

Infrastructure Wiretapping

Linking all transactions with the same person does not provide access to the decryption keys. These can be achieved by contacting the communication counterparties if these are not under investigation. However for investigation serious crimes under planning wiretapping is sometimes required.

Implementing secret wiretapping is however significantly weakening security in the entire setup as it is difficult to implement protection against all communication being wiretapped creating a total security failure in a totalitarian scenario.

If wiretapping was to be implemented it can either be part of a device approach incorporating similar to the theft control described later in this invention where devices are either made traceable to the owner on purchase or later tagged in operation.

More likely to be complete this would have to be part of the core virtual chip cards implemented as part of the core authentication process to create linkability and as part of the communication encryption to create wiretapping.

The scheme would use dedicated keys for each device or virtual chip card protected with mechanism similar to the reverse PACC setup where a series of steps would provide access to devices controlled by an identified entity. This is significantly different from using the same shared secret key in all devices. Such a shared secret key even if it was an asymmetric key is also known as the clipper chip approach and is extremely vulnerable to anyone getting access to this key as it could provide full access to all communication.

Features like these are not included in a preferred implementation.

Privacy Accountability According to Application

Assuming a standardised definition of the accountability established through a PACC, any session established can then be limited to applications according to the level of accountability.

From this follows the full elimination of the trade-off between security and privacy. Example credit-based transactions require a certain level of accountability depending on the credit amount and the loss. If the PACC is of type anonymous then only PULL-transactions or applications explicitly accepting anonymous contact can be initiated in this session.

Any session can be authenticated anonymously, using credentials to verify both positive (memberships, citizenships, tickets) or avoiding negative credentials (not on a criminal block list), temporary accountable (time-based or otherwise limited), reduced accountable (amount limit, legal requirement, etc.), default accountable (default process to access an escrowed identity), specifically accountable (for instance single trusted part in case of monetary credit), limited identified (only towards a non-accumulating trusted part) decentralised identified (but NOT traceable by infrastructure) and fully identified (towards infrastructure accumulating linkable personal data).

Any service can define its specific requirement for accountability. Similar any session will have an inherent accountability level. Matching these will then tell if a certain session is able to provide access to a certain service. If the session accountability is insufficient, then a higher level of accountability can be established by authenticating towards an appropriate PACC or dynamically establishing a PACC according to requirements.

Basically this will mean that infrastructure will be able to provide support to any type of service according to the inherent risk. For instance an anonymous session based on digital cash payments can achieve access to location services, information services and services where participants explicitly accept the risk.

Any temporary use of public access points or lending can thus be protected without leaving a trace sacrificing privacy. For instance libraries with internet access, Internet Cafes, Supermarkets, physical doors with access control etc. would all benefit significantly from this approach.

Managed Digital Signature

An important aspect of discardable Chip Cards is the ability to instantly revoke digital signatures even if the Chip Card tamper resistance is broken and at the same time sign with identifying Digital Signatures without creating linkability for anyone than the suppose part. Several different approaches can be used to establish this presently not solved aspect.

Firstly the private key of the signature can be encrypted with a key that is not present on the Chip Card. In order to Sign, the Chip Card will then retrieve the decryption key using a method that can be blocked without access to the Chip Card. After accessing the private signature key the decryption key and the unencrypted signature key is then deleted until next transaction requiring identified signature.

To make this solution perfect an unbreakable deadlock can be created by further encrypting this decryption key using a key stored only at the Chip Card and accessing said decryption key can take place either anonymously or using multiple occurrences of said decryption key encrypted so that each access is not linkable with the others.

Creating Instant revocability would just imply deleting the decryption keys or blocking access to the decryption key.

Another solution would be to store the identifying signature key in an encrypted non-linkable version (including salt and different hybrid encryption schemes etc.) at some or all Privacy Reference Points. When establishing an anonymous session the encrypted signature key is forwarded to the chip card which decrypts the signature key, sign the transaction and then delete the signature key. Instant revocability can occur by blocking access to the Privacy Reference Point.

An even third solution would be to use a managed Signing Server handling one or more Identifying Signature keys and forward a non-linkable or blinded fingerprint for signing. The signed fingerprint is then returned to the Chip Card and the blinding removed and the signature forwarded to the agreement partner. This should preferable use a mixnet to shield the session from linkage to the managed signature server.

The Signature Server will need a traceable authentication which can be either a Chip Card key or a Credential based solution. To create instant revocability, this authentication process can be cancelled at the Signature Server.

Other solutions could be a credential based signature using split credentials with any of the above principles to sign. Split credentials could be in the form of multiple credentials that has to be XOR'ed together to create the real signature, one credential in the form of an encrypted identification combined with a decryption key, or any combination of these including where part of the key is stored at the Chip Card.

Privacy Credit Card Payment

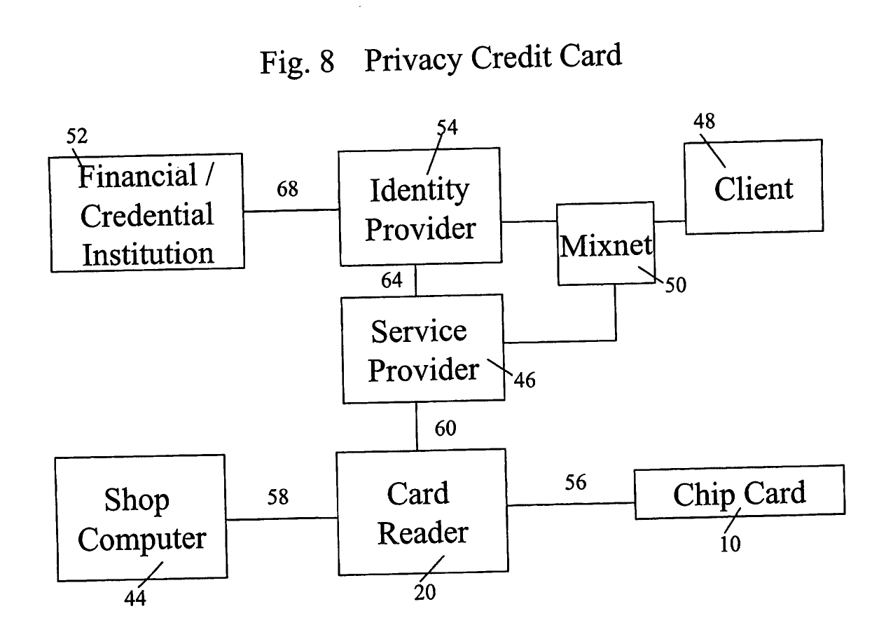

A preferred solution to Privacy-enable standard credit card or debit card payment is illustrated in FIG. 8. The Credit Card is assumed to be a persistent number related to a bank account and therefore provide identified linkage if a linkage between the persistent card number and the use of the credit card is stored in a database. The main objective is to break this link but still remain compatible with standard chip card payment interfaces such as the EMV standard (Eurocard, MasterCard and VisaCard).

The Chip Card (10) receives standard payment information from the Shop Computer (44) through the Card Reader (20). Instead of encrypting and signing the message and then forwarding the message directly to the Financial Institution (52), the message is routed through a double layer of pseudonymisers making the Identity Provider (54) act as the Shop towards the Financial Institution (52) independently of the real Shop Id (44). The Chip Card (10) creates an encrypted message attached to a one-time only Reference which is then forwarded to the Service Provider, who decrypts the message. The message contain information as to the Relationship according to FIG. 4 and an additional encrypted message with attached information to forward this message to the Identity Provider (54). The Identity Provider carries out the same operation to find an encrypted Chip Card payment message to forward to the Financial Institution naming the Identity provider the beneficiary of the payment.

When the Identity Provider receives a payment accept from the Financial Institution, a payment accepts is forwarded from the Identity Provider to the Service Provider. The Service Provider then emulates a Financial Institution towards the Credit Card Reader and Shop Computer. The actual Payment is routed the same way except that methods to prevent linking based on timing and payment amount incorporating for instance escrow and multiple payments crowd effects. Payment escrow can be established according to the consumer regulations of both the Client home country and the Shop Country. The net consequence is that the Financial Institution no longer knows who actually receive the payment, but convenience—and other wise this payment is standard looking from the point of view of the Shop.

The Shop Computer (44) can use a similar principle to generate a new one-time-only Virtual Shop interface for each transaction and hereby preventing the PRP-service provider to link multiple transactions with the same shop.

Theft Protection

If the chip card is lost the Client is in risk of impersonation and identity theft. The risk is dependent of the chip card authentication. Since the card deletes used References/Privacy Reference Points (PRPs) and healthcare data are encrypted the risk is limited to unused References, digital cash/credentials stored on card and digital keys for Privacy managed Digital Signatures.

To block for abuse Client only has to use the unused References to block for use of Digital Cash and credentials through the managed service. Further protection can be created by voiding References as well as Digital Cash and credentials marking them stolen. This way abuse attempts can easily be detected if a thief tries to abuse the card.

To block for Identity Theft using the digital keys for Privacy managed Digital Signatures, Client only has to connect to the Signature Provider and report the Digital keys stolen. The Signature Provider then deletes the copy of the digital signature encrypted with the keys specific to the card. After this the lost Chip Card has no longer any connection to the Digital Signature.

The Chip Card can further contain a one-time only reference to a Lost and Found connection similar to creating a standard Relationship except that this can be initiated by a Lost and Found office similar to an emergency health care unit connecting to Cave data. This is sufficient to establish contact in order to return the chip card.

Client can easily detect whether abuse has taken place due to insufficient chip card security. If security is violated and the thief has been able to use the chip card for transactions, the damage can be detected when Client traverses the unused References and appropriate measures can be taken without long-term consequences such as bad credit ratings etc.

Theft protection is also established on products, since leaving a store without privacy-enabling built-in RFID-tags means you haven't paid for the product.

In case of theft of a device such as a car, a shaver, a television, a mobile phone etc. enabled with Privacy Device Authentication, the thief will not be able to active the device because the thief will be unable to access the key. Similar to existing electronic theft protection of cars the theft protection depends on how perfect the digital authentication is integrated with the system.

Deliberate Lending or Sharing of Credentials

To prevent deliberate loss through lending, sharing, cross-credentials (a paedophile verifying for a drug addicts and visa versa) etc. the Chip Card should contain damaging access in case it is not blocked. In order to prevent selling access to credentials this can be linked with something the Client does not want to give away access to—such as bank accounts, establishing accountability or sign legally binding agreements, access the personal history etc.

A further important aspect to prevent lending of credentials would be to link Chip Cards in order to prevent exporting keys to non-tamper resistant Chip Cards.

Location

In the preferred implementation, no devices are identifiable towards external geographical location tracking as more than a session. To protect from abuse of the inherent location knowledge (as for instance triangulation of wireless devices) most services are blinded from their location through a virtual location somewhere on the network. This can be a proxy, several proxies, an inherent feature in the routing protocols, a more advanced anonymiser such as a mixnet or a combination of these.

The infrastructure access provider can provide services based on the location only and request further profile or accountability information according to the application. For instance a supermarket will inherently know that the customer device is located at the supermarket premises.

The wireless device either is able to define it own location using for instance a standard GPS satellite tracking device or as a service request from infrastructure tracking. But revealing the location towards any persistent pseudonym is in user control.

Devices can be pre-programmed to automatically attach the geographical position or even switch-on a persistent tracking functionality when calling emergency numbers. This invention will not prevent efficient aid to accidents, but it also follows that there is no inherent need for location tracking to be built into infrastructure for emergency purposes.

If devices are only traceable as non-linkable sessions, the access provider can provide the location information. In addition emergency services can be non-authenticated as the reverse authentication step for accountability is not relevant for emergency purposes.

If a Device is enabled with Privacy Device Authentication, it can be activated remote without privacy implications. For instance an authentication message to a car can be broadcasted in case of theft and thereby enabling tracking devices. A child can have a device such as a watch where an authentication message can activate any service such as a location reply etc. The child can have the option to deny the location request, if the focus is on the child right to avoid parent tracking. If the device is equipped with more than one authentication reply for the user—one type blocking reply if the user don't want to activate the function and another releasing a silent alarm in case of a criminal event, then a criminal can not prevent an alarm even by threats of physical harm.

Devices

The Chip card can be implemented in any number of ways.

Connected to an untrusted card reader using wireless or direct connections.

The dependence on an untrusted user interface can create a risk of man-in-the-middle attack in the card reader where user choice are altered in order to manipulate the chip card to perform an action the user has not authorised. A number of technologies and methods can eliminate this problem such as multiple purpose specific pin-codes, purpose specific Chip Cards (one for always anonymous and one for default traceable transactions) etc.

Distrust towards the financial institutions can make it preferable to implement a solution where the store chip card reader intermediate the shop as either the Identity Provider (54) or the Service Provider (46). The chip card will then make a payment authorization which can be encrypted by the chip card reader using the public keys and forwarded accordingly. This method can also protect ordinary credit cards. The central credit card databases thereby can no longer determine where payments are made from information available. If the Identity Provider forwarding the payment instruction to the Financial Institution—after payment is received—encrypt the data linking the transaction with the point of payment according using external keys, privacy protection of historic transactions can be achieved.

Further a Privacy Chip Card can be used in parallel with the non-privacy-enabled chip card to link the transaction to for instance a Basic anonymous Relation according to 110.

A better method is for the chip card itself to have a direct user interface for authentication and choice. This can be either using a more complex chip card or by combining the chip card with a trusted device incorporating a chip card reader. This device can be any type such as a pda (Personal Digital Assistant), a mobile phone, a portable computer etc.

The same effect can be achieved even with contact cards by making them able to communicate wireless with an external user device handling the user interface. Commands from the untrusted terminal can be ignored, validated or overridden depending on the implementation. The consequence is protection against untrusted devices.

The preferred solution would be to incorporate the chip card in a dedicated personal authentication device communication with other devices using wireless protocols. This way the same chip card can be used to control all user devices using privacy device authentication to establish control with the specific device.

This can be split into two devices in the form of Master Authentication Device (dedicated to handling basic keys and physical authentication across devices) device authenticated to a Master Communication Device (mobile phone, pda, portable, etc.) handling additional communication.

End-users can easily exchange devices through lending protocols as long as the Chip card is personal.

Protocols

Privacy Reference Points—PRPs

PRP is one-time only references acting as anonymous pseudonyms. They are created in such a way that only the Client is able to link multiple PRP created with the same Chip Card. Client can thus any communication channel including PRPs can be generated and shared in multiple ways.

The most secure way would be to generate pure random input numbers in a secure HOME environment and share these with the Chip Card.

These random numbers can be used to generate both a PRP as well as an authentication key.

Another way would to generate random-like input could be to use an algorithm based method using a shared secret as seed value. One such implementation could be based on a low-collusion hash of a combination of a CardRef (Chip Card specific key) and a changing part such as a counter.

Any stream padding chipher can generate a similar result—the quality depends of the degree of randomness of the algorithm.

The sharing can be carried out either through transferring PRPs (or seed secrets for an algorithm based solution) encrypted with the public key of a key pair, where the private key is generated within the chip card and has never left the chip card or a shared symmetric encryption secret for instance established sing a standard Diffie-Helmann protocol to establish a shared encryption secret or other means.

Another way would be to use a ring method, where each Privacy Reference Point when authenticated will forward a previously stored encrypted data segment which contains the reference to the next Privacy Reference Point.

Another way to share the PRPs could be to use Credential technology using blinded certificates.

Relationship Reference Links

In a standard credit card payment request transaction the store transmit as a minimum a Shop Id, a transaction reference, amount to be paid and a date.

When combining the Shop Id and an internal Relationship Link key, the Chip Card can generate a unit specific Relationship Reference Key for instance as a hash of this combination and use this result as a key for enable cross-transaction linkability and thereby the ability to build profiles across multiple PRP-based transactions.

Client can encrypt this key for his personal use and only make available for instance in the HOME environment ensuring NO ONE except the Client can link multiple transactions in the same shop and still maintain complete The key can be released directly to the Shop to provide in-store linkability without any part of the infrastructure able to link these. By including an additional element as a hash parameter, the Chip Card can maintain multiple persistent relationships with the same shop. This could a purpose-specific key or for instance be the date or year and thereby creating a new relationship each day or each year.

The preferred method to balance security, convenience and flexibility would be for the Chip Card to use two Relationship Reference Keys and encrypt the main Relationship Reference Keys with the public key of the Service Provider (46). The Service Provider can link the anonymous transaction to previous transactions with the same Relationship Reference Key and store a shop-specific Customer Reference with is returned to the shop together with stored profile information. The Service Provider has in the basic setup no need for accessing contents and therefore profile content can be encrypted so that the Service Provider only acts as a contact point providing storage, transaction, communication and trade support for relationship.

As a second shop-related key, Client can instruct the PRP-provider on which data profile to provide for the shop. Client can for instance create a fixed shared profile part and have the PRP-provide link to this together with the last months profile or simply provide the shop access to the full shop-related profile for maximum convenience.

This way the Client can independently of his own convenience decide his profile towards the shop.

Group Relationship References

The basic group connection is established as a number of anonymous Privacy Reference Points linked together in a group based on a shared Group Privacy Relationship Link. A public-private asymmetric key par is created and the private key is stored online in multiple versions—each encrypted with the encryption key of a member.

Any exchange can then use the shared key if all parties are to access this information or be directly addressed to any part—fully anonymous to central services providers. But members of the group can establish exactly the level and type of accountability preferred either using the setup described in this solution or voluntary as part of the relationship communication using any external solution including direct identification using a standard digital signature.

Privacy Device Authentication

To protect the Client from the environment tracing or collecting information as to the devices, he is carrying or accessing, a zero-knowledge device authentication can be used. The device requires the Client to prove possession of a secret key before activation. Prior to activation the device will in no way reveal its existence or reply to any requests. Similar the Client Authentication Device (CAD) need not reveal any information usable to link multiple transactions performed by the Client.

Since the surroundings must be assumed to listen to all wireless communication, replay attacks where an attacker records one authentication session and later replay the authentication to emulate Client must be prevented even if the device has no ability to store prior history. The preferred way to do this is to include a for the device method to distinguish between prior authentication attempts and valid ones. The preferred solution is to include a timestamp into the protocol and have the device store the timestamp of the last successful authentication. In case of a replay-attack the device will simply ignore the authentication attempt.

For high-power devices with sufficient computational power an asymmetric key pair can be used. Each key can be used as a private key towards the other and thereby facility a two-way authentication. One key advantage of this implementation is that the private key of the device is not known outside the device making man-in-the-middle attacks harder. The same key can still be used for authentication, encryption and decryption but always used in a zero-knowledge protocol preventing externals to identify and link device usage.

Each device can have multiple key pairs to reduce linkability across use. This is especially vital in any direct device connection between a trusted environment such as the HOME environment and an external environment such as such as a commercial entity.

The root security principle invented and implemented through this invention is that any direct device identifiers such as encryption keys never has to leave the trusted environment—communication should preferably take place through context-specific pseudonyms to ensure non-linkability and flexibility.

If a direct device connection has to be established for any purpose this should always be using a dedicated key pair that is not reused for anything else.

Addressing should preferably be relative such as a PRP.<virtual device-identifier>or be type reference such as PRP.<DEVICE TYPE Identifier>.

A unique serial number provided by the product manufacturer is consistent with this by providing support for the Product life cycle until purchase and being linkable to the purchase PRP. In the phase where the product is in end-user control this unique serial number is always replaced with context-specific key pairs and preferable not addressed directly at all. This way the unique product serial number is therefore transformed into a protected root device identity.

Device with Low Computational Power

For devices with insufficient computational power such as RFID-chips asymmetric computing is not feasible in the short term due to the technical requirements. Here this invention introduces the concept of light-weight Zero-knowledge authentication.

This involves any algorithm that satisfies the requirements of authentication without transferring other than random session identifiers for either device involved in the communication.

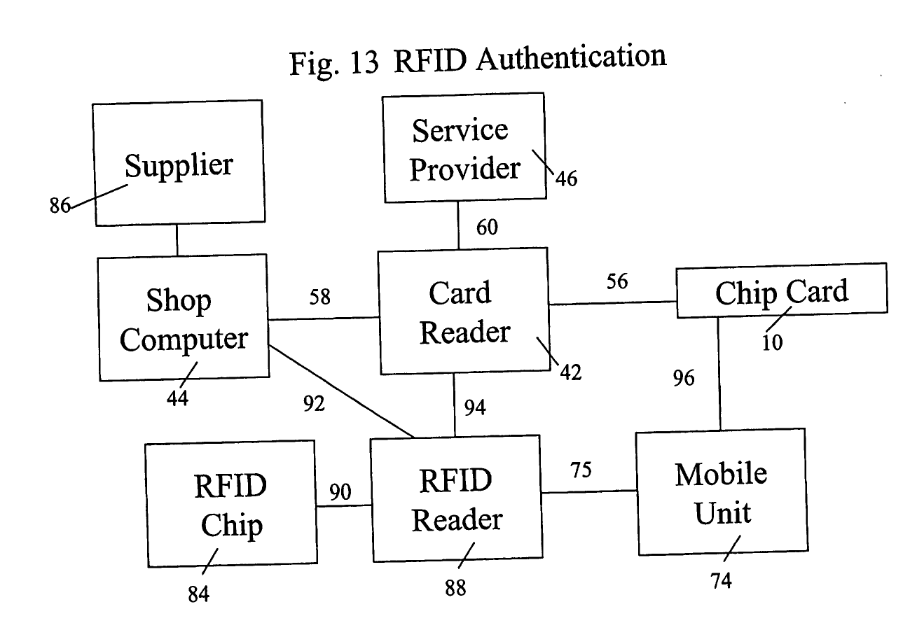

Using such an algorithm shown in FIG. 13, this can enable communication from a Client-controlled chip card (10) through either a Privacy Authenticating Device (74) or a untrusted Card Reader (42) through any communication network such as a LAN, WAN, WLAN, Bluetooth (94) to forward or broadcast a message through a communicating device (88) enabled for transmitting using any protocol such as an RFID, IP, Bluetooth, WLAN, infrared, radio waves etc. with the device to authenticate (84) such as an RFID-tag, a Bluetooth-tag, a WLAN card, a radio wave reader etc. The device (84) can further be integrated in for instance a Car and thus act as a digital key towards any other device.

One preferred algorithm that abide to the tough requirements involve the Chip Card (10) to generate a message comprising a timestamp (DT) together with a first data segment (X1) and a second data segment (X2) encrypted in such a way that the device to be authenticated (84) can verify the authentication using a stored secret (DS) and verify the authentication is not reused by checking DT2 is newer than the timestamp of the last previous successful authentication (DT1). In the preferred solution, X1 comprises a one-way low-collusion hash algorithm such as MD5 of the combination of the device secret (DS), a random session key (R) and the timestamp (DT2). X2 comprises the XOR combination of random session key (R) and a hash of the Device Secret (DS) and the timestamp (DT2).

The device receive X1=H(DS∥R∥DT2), X2=R XOR H(DS∥DT2) and DT2. If DT2 is less than or equal to the stored timestamp of the last successful authentication DT1 then the authentication fails. If not the device then computes the random session key using the stored device secret (DS) so that R=X2 XOR H(DS∥DT2) and verify the authentication by checking that H(R∥DS∥DT2) equals X2. Since only a Client device knowing the stored secret (DS) would be able to compute X1 and verify X2, the device can assume it is authenticated by the proper owner and can now respond accordingly.

To verify to the owner that the device knows DS it only needs to prove in zero-knowledge that it knows R. This can take place by returning for instance X3=H(R). An authenticated session between the two devices is now established with a random shared session secret R to encrypt any message using any encryption protocol.

A command or reference could be included as a fourth parameter. One use of this is if the Tag contains multiple keys to help the key detect which key to check against in order to save power. Another is to issue specific commands such as Transfer, create new keys or open for access to authenticate hidden keys.

Creating the Initial Device Secret

From factory the Device or product is part of a supply chain where unique numbering is key to effective processes—privacy protection is not an issue and only a problem. The change from a non-privacy to a privacy enabled device occurs at point of purchase (which again can be multiple steps for instance in case of lending etc.). Multiple different algorithms and control procedures can ensure this change occur in a secure manor.

A simple preferred method if for the product from factory to have included a unique Serial Number (SN), an Privacy Activation Code (AC) and in case of activation a fixed initial Device Secret (DS). When the product is purchased AC and DS is transferred to Client and the AC further transferred to the Device in the open. On first Privacy Device Authentication using the initial DS, Client is required to alter the DS-code to a new randomly selected DS. By including a block never to reuse the initial DS, Clients are safe against even against collaboration between the shop and the producer to listen-in to the communication between Client and the device. In case of an attempt to use the building DS, the attacker will be forced to change the DS and then the Client will detect it on first use as Client will not be able to authenticate with the DS provided. If Client doesn't want to use the ability to authenticate towards the device (for instance a piece of clothes with an RFID tag) then the device will for all practical purposes be privacy activated.

Privacy activation linked to purchase implements a strong theft control enforcing privacy. If a consumer leave a store with non-privacy activated devices, he should be stopped—either due to an attempted theft OR because the privacy activation does not function properly. This provides a positive interest in safety for BOTH the consumer and the shop.

Forward/Backward Secrecy of Shared Secrets

In a more advanced implementation than the basic protocol, the shared secret changes every time. The RFID protocol in itself is Zero-Knowledge (see the enclosed paper discussing these issues), but if an attacker somehow could get access to the shared secret, this would mean that historic recordings of communication could be decrypted and linked. To prevent this, an additional aspect can introduce backward (an attacker having learned the shared secret also breaking previous recorded sessions with the same device) and forward (successful tracking and linking any later sessions) secrecy by changing the shared secret in every step. This can be done in a special step after authentication, but a more simple way would be to make use of the random session key, R.

Forward secrecy would be ensured if the attacker misses only one change since there is no algorithmic model when incorporating a random element at every change. Due to the short distance and especially mobile nature of most applications this is a highly realistic assumption unless the attacker is closely tracking the user or the user only accesses the device on predictable occasions and channels which are all broken.

Backward secrecy can simply be implemented if the New Shared Secret involves and operations including the old Shared Secret and the random session key R. The easiest solution is to calculate the new Shared Secret from a hash of an XOR combination.

The RFID will acknowledge an authentication with change of shared secret by responding with a zero-knowledge function that can only be computed with knowledge of the new shared secret. Since the new shared secret is calculated and not transferred, responding with an operation involving the new key would be sufficient to demonstrate knowledge of both the old Shared Secret and R, but many different formal specifications could be used; one advanced Acknowledgement could be
ACK=H(H(New Shared Secret) XOR Old Shared Secret) XOR R

The problem of key synchronisation can be solved if the RFID stores both the old and the new shared secret. The owner will only shift to use the new shared secret upon receiving the proper acknowledgement. Until then the owner will continue to use the Old Shared Secret assuming an error in communication. The RFID will listen after both the Old (present) and the New (assumed) Shared Secret. When an authentication attempt with the New Shared Secret is received, the RFID will know that the Owner has shifted to the New Shared Secret and replace the Old Shared Secret with the New Shared Secret and repeat the process of generating a new Shared Secret.

When an authentication attempt for the Old Shared Secret is received, the RFID will assume that the previous acknowledgement was not received by the owner and subsequently discard the assumed New Shared Secret reverting to the Old Shared Secret and resume the process of generating a new Shared Secret from there.

Two-Phase Authentication for Authenticity or Dynamic Access Control

Introducing multiple authentication keys according to the basic principle with different access level or rules provide very strong new security features despite the lack of computational power.

For instance the issue of product authenticity to prevent fraudulent copying of products is highly usable in a long range of applications with branded products, for security purposes or for updates etc.

One such implementation would be created if the RFID tag Owner first authenticates with command to accept a second authentication towards a key that would otherwise remain inaccessible such as an authenticity check. The Tag need only use one bit to store that it should accept only one attempt to authenticate towards the hidden key.

The Owner then claims the product id by reference (such as an EPC number that does not need to be stored on the Tag as the Owner is actively involved) to the Retailer or directly to the Supplier. The Supplier (or a Authenticity Service Provider on behalf of the supplier) receive the message and use the claimed product id to make a lookup in his table of Product Id-Authenticity Keys. The Supplier then makes use of his Secret Authenticity Key to generate an Authentication message which s forwarded to the Tag. Upon receiving the reply from the Tag, the Supplier knows that the Tag was in fact the specific claimed Product Id. Since by the nature of the protocol this can be done through relaying, the Supplier never has to share the Authenticity Secret with anyone.

The Tag will in the process of Authenticity Authentication clear the bit and return to Privacy Mode where it will no longer accept authentications towards the hidden key. If the authentication for any reason fails, the Owner can initiate the process again.

The same principle is highly usable for a long range of different Applications where the Owner creates a dynamic session key which can be temporary, delegating, access limited or any combination. A simple aspect is the ability to change the product price in a retail store but not initiate an ownership transfer. An advanced application example would be for the doctor to create identifiers that would be used by a healthcare application to grant anyone participating in an operation and have knowledge of the key a context specific 60 min access to parts of a healthcare patient file during.

One aspect of RFID authenticity is the ability to improve authentication of Identity devices such as a MAD-device incorporating a secure chip card combined with the ability to communicate. User authentication towards the MAD is based on passwords, having the physical device, biometrics towards templates etc. and can be augmented with a RFID Tag that the MAD require to be nearby. The MAD authenticates towards the MAD which then try to detect a specific RFID Tag nearby which can be worn by the owner or even surgically implanted. When context is established the end-user can create a context-specific dynamic session key for re-authentication and define its limitation in time and access rights. This way the enduser can define balances between security, tracking and convenience varying from application to application.

If the MAD-device or the RFID are further combined with a GPS or other geographical location-sensing device, then linking the MAD-device GPS with application or sensor-based GPS can protect against a relayed man-in-the-middle attack.

Group Privacy Device Authentication

The basic Privacy Device Authentication protocol requires the owner to know the device to authenticate. In a number of circumstances this assumption does not apply and a group authentication protocol is needed a first step before the actual authentication protocol.

Such a protocol could in a preferred implementation include storing an additional Group Code (GC) stored on multiple devices and a Device Identifier (DI) chosen specific by the client for the single device.

The Group Privacy Authentication protocol includes a first authentication step using the Group Code (GC) instead of the Device Secret (DS) establishing an encrypted session with all devices storing the same GC.

In a basic solution all devices can respond with their respective Device Secret (DS) XORed with the Random Session key (R) or a group specific random Device Id. The Client then looks up all the received Device Ids and retrieve the Device Secrets (DS) for the devices to authenticate.

A better and more general solution would add a vital privacy and security protection of linkability in case an attacker has been able to guess, break the algorithm or access a valid Group Code (GC). Instead of providing the Device Secrets as respond to the a Group Authentication the RFID operate a list of one-time-only references or encrypted references revealed one at a time for each transaction. The references can only by the intended entities be translated into the real devices identification.

This is very useful for HOME applications where the Client is intended to be able to change settings such as washing machines, television, refrigerators, room temperature etc. as the purchased product can be extended to include specific information for specific usage or processes such as re-ordering (refrigerators, coolers to remember and provide services on content and duration), adjusting programs (washing machines clothes etc.), preferences (loudness, preferred tv-channels, light etc.), proximity services (door opening).

Another important solution and application is where the list of references consists of a list of encrypted PRP-references and authentication keys which extend the HOME applications to general usage. A Group Authentication will not be followed by a Device Authentication as this would create linkability across multiple transactions with the same device.

In this range of applications the provider of the application service will connect to the PRP and either the application service provider or the Service Provider (in case of a managed service) respond with for instance a timestamp (and potentially a ticket number or other specific information such as a distance, location, section, seat, price range or other ticket specific information) defining the time period this specific ticket is valid.

Subsequent request within this time-period will then result in responding with the same reference (plus concatenated additional information). By letting this time-stamp extend beyond the real end-period and combining this with a kill reference command extensions etc. can be purchased by linking multiple PRPs in a repeat request in a session.

This is especially useful for applications where the same Group Key is used as for cross-Client Applications. This could be for a ticket system for use in transportation, car parking, road pricing, physical access system, events etc.

Even tickets for One-time-only events can be integrated in cheap multipurpose RFID tags by purchasing the ticket and then create a PRP storing all the relevant event information and prepare the RFID reference with the relevant information and Group Code. The related Group Code is provided by the application Service provider as part of the ticket purchase or by the Service Provider as part of a managed service.

This can easily be extended to multi-ticket applications even across difference applications either prepared by the Client separate agreements or as part of a tour package with the Service provider supporting with managed services for operations (flights, car renting combined with hotel reservation and conference registration).

If the actual application information is stored at the PRP encrypted for the proper recipient and with the additional possibility of authentication towards the PRP-provider to make Secondary abuse is difficult.

One key addition to this solution is the addition of an authorisation Code, where the RFID release a session specific authorisation to the PRP-provider to release the payload. A simple way to do this is for the RFID to shield the authorisation Code with the Random Session Key

Authorisation Code shielded with the Random Session key; When authenticated by a Group Authentication, the RFID returns Ref and Code=H((R xor AC). Provider contacts PRP entity and authenticate to the PRP. Provider sends En(Ref+Code+R, PRP.Pub) to PRP entity. PRP entity returns ticket contents

This way a value payload is not released unless the RFID has authenticated in the actual session. A way to reduce the attack scenario further would be two-use a two-phase authentication protocol where the front-end such as for instance a ticket checker authenticated with a group authentication key and receive a reference to the PRP-provider. The front-end then establishes a session with the PRP-provider through which the PRP-provider authenticated zero-knowledge with the RFID. In most scenarios the front-end will be in real time connection to the PRP provider but in distributed scenarios where the RFID is a generic solution and the consumers have different PRP-providers, this connection can be created on the fly.

The PRP-provider then authenticates related to the specific event such that the shared secret only is stored by the PRP-provider and the RFIDs themselves. This is similar to the Product Authenticity aspect.

Privacy Delivery with RFID Technology Managed Legs.

With this RFID technology in place a physical package can be tracked and rerouted in transition. The RFID can from remote be enabled to Privacy Mode like this.

The producer of an RFID creates a standard RFID with a predefined one-time-only authentication key that enables Privacy Mode and a key encrypted with the public key of a third party that upon purchase is released to the purchaser. This RFID is distributed through normal distribution channels. When the purchase is made the encrypted key is released to the end user who then contacts the service provider using a secure and anonymous channel to get the encryption key decrypted. If multiple attempts to get the key decrypted is attempted there is a potential violation of security.

The end user can then encode each leg of the physical delivery with different Group Authentication Keys and links to central but anonymous and non-linkable PRPs. At the PRPs the user can store updates for dynamic routing, contact information for notification or coordination of alternated drop points etc. The RFID can be such encrypted that each leg upon authentication the first time deletes information as to the previous leg. The package can shift identifier from one leg to the next. In case of problems coordination can take place through the PRP-link. At the last leg, collection or delivery can be according to the user discretion. Since the RFID contain authentication ability, then the proper own can prove ownership simply by proving the ability to authenticate towards the delivery RFID.

As such psychical delivery can be anonymous, coordinated and still utilise all the efficiencies of RFID and intelligent communication support.

Device Able to Handle Asymmetric Encryption

As shown above Privacy device authentication can even be carried out using weak authentication mechanisms.

The preferred and likely standard method will be to use strong encryption using asymmetric or even credential encryption in a zero-knowledge implementation. For instance the entire Zero knowledge Device Authentication message be symmetrically encrypted by the Shared Secret or making a hybrid encryption using an asymmetric key pair where each device use one of the keys for both encryption and decryption.

A device able to do strong encryption can always emulate the weaker encryption protocols described. For instance it is impossible for a reader to detect whether a proximity badge is a weak computational power RFID tag, a somewhat more powerful Bluetooth tag or an advance Master Authentication Device with full key management and access to WLAN, 3G or other communicational channels in parallel with short range wireless protocols such as RFID-communication, Bluetooth, infrared or other local communication protocols.

In the purchase process the Client assumes control of the device and either the device or the Client creates a device-specific secret public-private asymmetric key pair. Secret means that it is NOT shared beyond the device and the owner. Delegation is preferably done through additional secret key pairs to distinguish between owner/(administrator and temporary delegated authentication with reduced access.

The private device key is blocked in the Device.

When the Client wants to assume control any communication package can be encrypted using the public key WITHOUT attaching any identifying certificate or persistent identifier. To an external observer EACH package is zero-knowledge communication.

If the device is able to decrypt the package with successful result the device can assume that the sender is the owner of the device. Date stamps or challenge-responds mechanisms should be included to protect against replay attacks, but without knowledge of the secret public device key, the attacker is not able to neither prepare nor decrypt a device message.

A stronger authentication would include a two-way authentication which is especially useful when using context-specific device keys towards specific parties, which is similar to the workings of a virtual identity with encryption keys managed within the chip card.

Mobile devices don't have to generate PRP-specific asymmetric keys themselves. Each PRP and later each relationship-linked set of PRPs can have a prepared set of asymmetric keys stored and encrypted with a card specific decryption key. When the PRP is authenticated, the specific asymmetric are forwarded to the mobile device and decrypted. Similar the public key of the asymmetric key pair can be linked to the PRP in advance towards the PRP-service provider in order to make the authentication process first based on a light-protocol followed by a strong authentication based on the ability to decrypt and access the private key.

Asymmetric Device-to-device authentication is simply based on an optimistic principle where the slave device test all approved keys at each authentication request.

X1, X2 and X3 can be combined in one encrypted package so that for instance X1=Enc(Timestamp∥R∥h(R), Device Public key) in the one-way slave mode and in the two-key version X1=Enc(Timestamp∥R∥Enc(R, Privacy Master Key), Device Public Key).

Similar group authentication is simple as the shared secret is exchanged with the public key of the group authentication key and the validation switched to strong encryption without exchanging certificates or keys that are not session-only.

TRUsted Secure Computing Traceable to Tamper-Resistant HardWare—TRUSTHW

One of the key aspects of security is how to avoid attacks on the security software and core operating systems. If attackers can replace software with their version they are able to do a man-in-the-middle which can lead to a long range of security problems. The present approach to counter this is to lock digital keys in tamper resistant hardware and then bootstrap the system start-up and communication in a way to create traceability of any key, piece of hardware, software or transaction employed. A key pair is generated in hardware and used to generate and sign new key pairs, where actual control of privacy keys never leaves the piece of hardware. Any signed and verified transaction is therefore directly traceable to the hardware.

Applying Trusted Third parties etc. does not change the fact that CONTROL is not in the hands of the individual, but in the hands of EXTERNAL entities, but ONLY if they can verify this unbroken link to hardware CAN a specific key be considered Trustworthy. This trust is essential for Digital Rights Management in its widest context including protection against both deliberate and hidden malicious software in the core system.

However even though this may create security versus third party attackers, the consequence is that linkability destroy data security versus the communication partners and the infrastructure. Similarly there is a significant problem of targeting specific systems enforcing any software update. In other words presently there is a trade-of between security against third-party fraud on one side and individual data security and privacy on the other.

This invention establishes a novel model implementing Virtual Systems and Virtual Identities in which linkability across multiple transactions is under control by the individual owner himself.

The core element in ensuring this can work is the notion of anonymous hardware traceability. In other words to establish traceability to a hardware standard specification (e.g. category information such as version 5.7 with a related certification key) documenting that keys are hardware-controlled but NOT exactly which piece of hardware (Product Id such as an ePC number).

One way to do this is through the use of tokens, a blinded signature or credential integrated into the hardware itself in such a way that the hardware can generate multiple virtual systems without disclosing its real identity.

In a preferred implementation the hardware contain the ability to generate asymmetric key pairs such as for instance RSA keys within a tamper-resistant processing unit. Tamper-resistance means that keys will be destroyed in case anyone attempt to physically attack the hardware to get access to the keys.

The hardware is by the manufacturer equipped with a Hardware Key pair (HKP) that is certified by the hardware manufacturer to the piece of hardware itself in order for the hardware to be able to prove that it is the hardware towards anyone.

When the hardware is instructed by the user to generate a virtual system key, the hardware use the HKP key to sign a request for a credential from a third party verifying the hardware specifications. The third party upon recognition of the specific hardware key generates a credential and encrypts the credential with the public part of the HKP key and returns this. Only the hardware can decrypt the credential which is therefore completely locked to the hardware itself. The hardware then create a new Virtual System Key Pair (VSKP) and anonymously link the public key of this VSKP key to hardware specifications using the credential according. This combination is then signed with the private key of the VSKP key pair. This key can now be verified by any external part to be traceable to hardware and thereby under hardware control, BUT not traced to a specific piece of hardware.

If this VSKP key is only used as a pseudonym or as an attribute to a pseudonym through for instance an anonymising mix-net, third parties are know able to verify anonymously that the pseudonym is traceable to hardware control under known specifications without being able to know WHICH piece of hardware of the many possible.

This is perfect for DRM use as content providers can now encrypt content using a VSKP key and rest assured that the content is treated according to known specifications without having to identify the device or the user.

Upon accessing DRM-protected content the hardware specifications in one implementation define under which circumstances the decryption key to the content will be decrypted and re-encrypted for another pieces of hardware such as a media player or a basic system CPU etc. Thereby Anonymous but secured DRM is enabled traceable to known hardware specifications.

A key application is enabling the ability to bootstrap a trusted system only using certified hardware and certified software components while still being able to introduce new components to the system anonymously.

As such is reduces the control structure to a question of standard specifications defined by certification traceable to defined Root Certificate Keys to work across providers and tools. A key element is that the technical properties do NOT result in additional information leakage traceable to devices or users.

Hardware Traceable Creation of Identity Escrow—Freedom with Responsibility.

A key feature of this aspect of enabling anonymous hardware traceability is the ability to incorporate client-side creation of Identity Escrow certified by the credential to be according to specifications. Trust towards an entity is therefore not required if hardware can be trusted.

This aspect enables the ability to create Accountability without Linkability in the sense that a session can be accountable without different sessions with the same device becoming linkable.

The default model for this described in “Establishing a Privacy communication path” as two trusted parties in serial where the first party establish guilt and the second party verify on behalf of the accused that due process has been adhered to.

By managing published lists of Trusted Parties, Time-limited Keys or other Escrow Primitives, the Client-side hardware can generate PACC without any central entity involved.

New primitives can easily be included incorporating for instance contracts with token-based milestones so that Identity Escrow is conditional to an entity NOT meeting contractual terms. For instance an instalment on a loan can be released to the lender upon release of a credential verifying payment towards a hardware-based trusted part acknowledging that the contractual agreement has been meet and subsequently the ability to re-establish identification has been terminated.

Similar this would mean that convictions of contractual default can be automated and proof of Identification released with very few costs involved.

This also means that Identity Escrow can be tailored to context risk profile by end-user devices meaning that counterparties can verify in realtime exactly under which terms or procedures Accountability is ensured. Example is within three months Trusted Party A can upon certain conditions lead to re-establishing of identification.

If these conditions are unstructured then trusted parties such as judges or legal entities can be included. If terms are not meet such as a product warranty terminating without claims within the determined time frame, the keys to open the Escrowed Identity is deleted from the hardware device and identity can never be re-established.

Additional Characteristics of TRUSHW.

It should be noted that this aspect of traceability to Root Certificate Key under external control is also highly usable to restrict who can provide services, components or content to the trusted system.

Even though the basic solution solves the direct ability to do this by limiting the HKP-key to creation of new credentials, the Trusted party might introduce conditions to issuing credentials. One implementation that would solve this problem would be for the hardware early in the production process to have installed a significant number of VSKP-credentials before the user gets the system under control. A weakness with this approach might, however, be that credentials already at point of sales have been showed the limited number of times making the next show identifying through the ability for the Trusted Third Party to open and link the various credentials.

Another aspect discussed is the ability for the end-user through a physical button to require the system to accept software or hardware NOT certified by a key traceable to a Root Certificate Key and thus overriding attempt to enforce a policy on Fair Use. This aspect would in combination with the ability to act under pseudonyms introduce absolute end-user control, but this could introduce security risks limiting external trust.

This invention enables the ability to make a fine-grained implementation of Fair Use in the sense that categories of hardware, software and contents can be transferred to End-User control. One example would be to disallow a provider of computers to enforce a policy that only devices produced by him can be attached to the system.

The hardware specifications can contain specific requirements related to time, the composition of system components or users. This can be maintained through either regular renewal of credentials OR session verification according to for instance the anonymous PRP-principle.

One use of this would be for employees of a company storing corporate information on a home computer to loose access to corporate information stored at home in case of change of authorisation. This could be related to a termination of employment or just a change of job description.

Another use would be in case of a detected flaw in the hardware specification making it vulnerable to attack to terminate use until specific and certified updates has taken place. It should be noted that this property is also highly usable to restrict who can provide services, components or content to the trusted system.

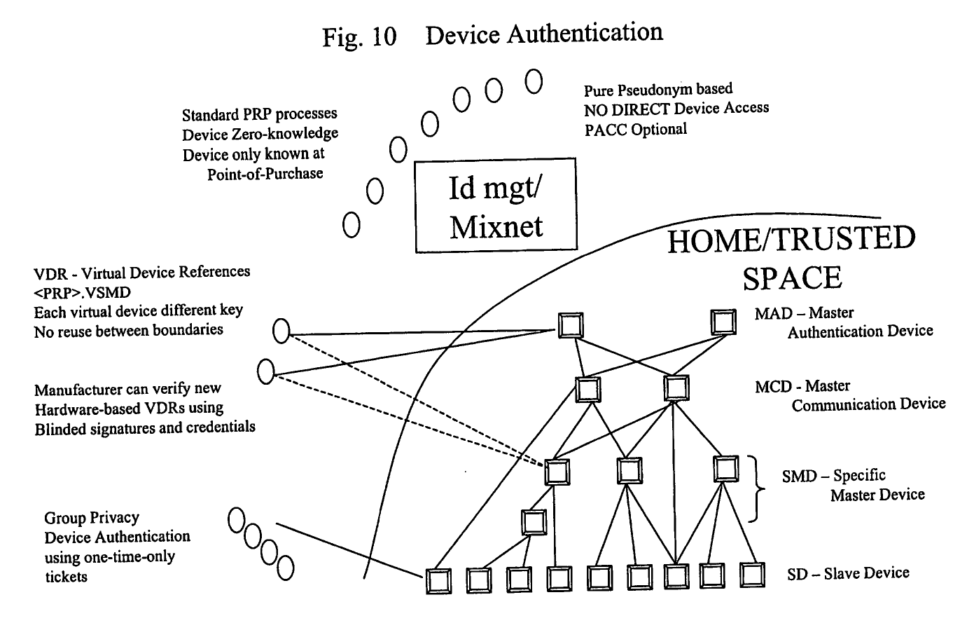

Another use would be to apply user credentials in such a way that for instance convictions of certain crimes leads to the user to loose rights to certain credentials which can reduce rights for anonymity. The user can be blocked out of the system until certain properties are restored. One property could be to establish linkability between the various Virtual Systems or even to provide access to privacy keys. In a specific implementation such a TRUSTHW virtual machine is combined with user-specific keys to create a Master Authentication Device (see The Digital Privacy Highway FIG. 10). User-specific keys include the ability for the end-user to authenticate using biometrics, passwords or any interaction towards the MAD device in order to activate the external virtual identity key.

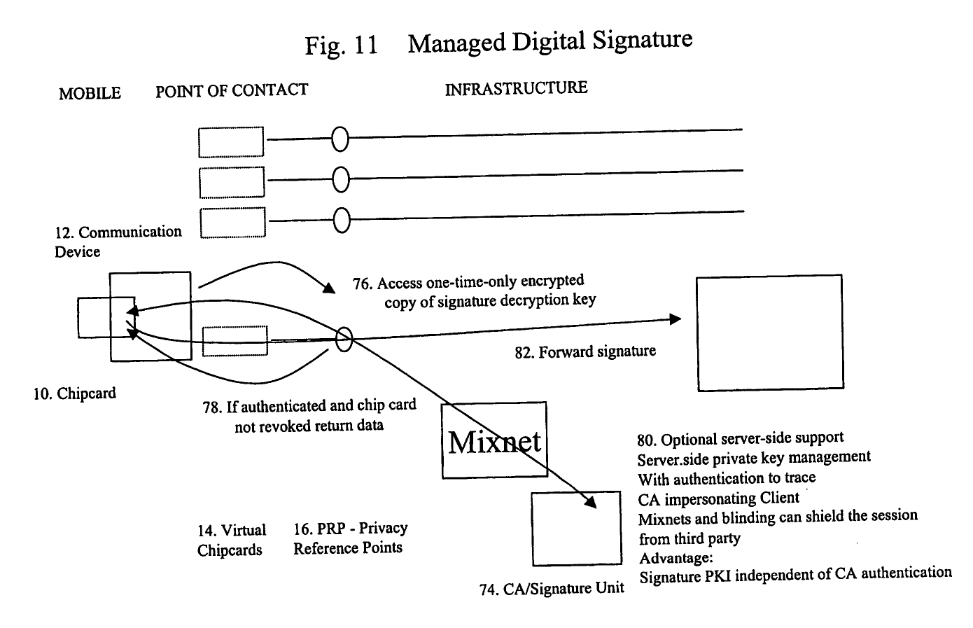

A MAD-device may itself contain biometrics readers or make use of a Slave device to read biometrics in order to compare these with stored and hashed templates. Upon match the MAD device can use the advanced revocation control features described in FIG. 11 on Managed Digital Signatures to get access to stored sensitive material such as Digital Signatures or unencrypted certified biometrics still retaining the ability to instantly revoke the MAD-device for any future abuse.

In a very important specific implementation the MAD-device authenticates towards a TRUSTHW device with the ability to show a stored biometric such as a picture or a fingerprint WITHOUT transferring the rights to store the biometrics in an unencrypted fashion. This is highly useful at borders since the biometrics NEVER leave individual control and still the border control officer is able to visibly verify the biometrics in case there is a need to check further. The passenger can voluntarily reveal any information or credential necessary.

In another important specific implementation at the border station this can be used to ensure that checks of biometrics or against block-lists does NOT leave biometrics in the open to be collected and stored centrally for secondary purposes.

This can even be done in such a way that the user authenticated over an anonymising network to a Trusted Third Party receiving a credential that the person is NOT wanted or otherwise not cleared for exit or entry into a country without leasing information as to WHERE he is actually is.

In a special implementation this can be used for a passenger to require a Temporary Residence Credential so that the passenger after biometrically traceable Identification can leave a virtual identity to work for the duration of the stay in the country together with credentials and identifying information that CAN be opened under specific pre-defined circumstances of which one is time-limitation. Upon leaving the country the passenger can receive a certificate of departure which is used to clear the Temporary Residence Credential and a new issued for the next border entry.

It is worth noticing that a mobile TRUSTHW device authenticating using reverse authentication towards a PRP as described in The Digital Privacy Highway can be biometrically identified, traceable to known tamper-resistant hardware specifications, legally accountable for all actions, instantly revocable in case of theft, cleared for any purpose using credentials and still remaining pseudonymous and still only leaving electronic traces within the session itself.

Context-Specific Privacy Contact Points (CPCP)—The Concert Problem and Instant Messaging.

Each part publish this days (or other changing component such as an event or context specific key) version of his preferred address book relationships.

An instant messaging link message—a CPCP—could for instance be created as <PRP-domain>.hash(relationship secret XOR Date/Event/etc).

The Instant Messaging Provider is then able to match relationships efficiently across multiple PRP-domains by forwarding the PRP-specific CPCPs to the relevant PRP-providers only. This also links different Client across multiple Instant Messaging Providers.

Accountability is an orthogonal issue as sharing a PLIM does not establish a connection until authentication towards the PRP-connection is carried out. This way loosing a Privacy Chip Card does NOT give the thief access to Instant Messaging Relationships AND at the same time requirements to accountability abide to the requirements of the various relationships independent of the Instant Messaging Provider.

One consequence is the ability to link a mobile phone through Instant Messaging to any other IM device connection in a privacy enabled manor WITHOUT creating persistent linkability. I can ALWAYS be in contact with MY relationships without infrastructure tracking us.

Shielding the PRP-domain as part of the hash is more secure for small domains (the domain should not in itself be revealing but commercial agreements could introduce discrimination) but this leads to a problem of linking across different Instant Messaging Providers and different PRP-domains. One solution would be to make the PRP-part connection specific so that the Client Device tells the Instant Messaging providers to try matching ALL CPCPs towards a list of PRP-providers.

Relationship parties do the same and upon matching Instant Messaging linkability is established without the messenger service knowing who talks to whom.

Since a Relationship secret can be related to a Group Relationship combined with intra-group relationships this concept can be used for Groups, communities and can even be nested in multiple layers. Example members of Community SMARTGROUP all publish a Group CPCP and subsequent to authentication towards the group publish a local CPCP relative to the Group to create group-specific Instant Messaging.

Relationship Communities

This Group Relationship also provides for Instant Message relationship linkage as a Group community can consist of a temporary community of all the relationships of one Client. For each root relationship both participants define if this relationship is visible and available to relationships of the other party. If so, when creating the Instant Messaging keys special indirect relationship keys are created to avoid sharing the basic relationship secret. The Indirect Relationship keys are defined to be non-unique so that they only make sense relative to a specific Client.

In other words ALL Clients reuse the same reference keys and the links are temporary. However, if two Clients in a temporary community decide to remain in contact they can create a permanent relationship.

Each time Client creates these context-specific communities new reference keys and related authentication keys are created and shared when an Instant messaging connection is authenticated.

Nesting this setup will result in relationship chaining. In other words for second or deeper level access where a relationship of a relationship asks to access a Community a request to get access to the temporary community keys and list of relations can be forwarded either automatically or on request.

I throw a digital party. You are all invited and bring your friends and the friends of your friends!

General Infrastructure

This principle of non-linkability of instant messaging relationships even across Instant Messaging Providers is highly useful for a multitude of purposes in Infrastructure. For always-on mobile phone can remain anonymous and still be reachable by selected members of the Client address book.

By creating services of published Telephone books or other types of publishing of contact information in relationships where the Client access this through a pull mechanism such as a mixnet and the CPCPs published using a mixnet combined with reply-blocks the existing telephone system can be entirely privacy-enabled entirely eliminating the destructive trade-off between privacy, accountability and convenience.

Device to Device Authentication

A key part of this invention is the natural continuation of device authentication into Device-to-Device Authentication.

The key principle is that device in a local and trusted environment can be linked whereas external connections ONLY can be linked or connected through a shielded session or relationship. Devices cannot be direct addressable using a persistent identifier by any external party in either infrastructure or in the ambient space because this will create linkability outside Client control.

Device to External Device links can only be relative to the specific relationship in such a way that the device cannot be addressed outside the relationship.

In many situations in a local and trusted environment it is advantageous to delegate device control to other devices. This could be the case of a master key device in a complicated multi-device product where control over minor devices is transferred to the central key device.

Examples could a computer (CPU, keyboard, memory, mouse, storage, input/output device, network adapters etc), a car (ignition, doors, multimedia equipment, petrol tank, network adaptors etc.).

Other natural would be linked appliances in the home such as multimedia (television, radio, CD/DVD/digital players, computers, loudspeakers, remote controls, set-top boxes etc.), the kitchen (cookers, refrigerator other appliances), the home office (printer, computers, access, servers etc.), the system (heating, lighting, ventilation, etc.), the security system (doors, alarms, windows, outdoor lighting etc.).

It could also be a combination of these such as a car authenticating towards the gate and door opener to the garage.

The preferred implementation of this would be for the Client to have mobile Master Authentication devices specialising on key management and controlling specific Master Communication Devices (such as mobile phones, computers, etc.) which again control Specific Master Devices such as household intelligent network server, cars, workplace, home office, other Specific Master Devices etc.

In the bottom are the simple slave devices controlled by product tags such as RFIDs, Bluetooth tags or more advanced computational tags. These can both be simply attached to the product/device but also integrated and controlling some function such as a door alarm, the coffee machine, a garage door opener etc.

Each person will have at least one Master Authentication Device for mobile use (reduced functionality to protect against loss or theft), a more powerful home device, a backup solution to transfer control to new devices in case of failure etc.

At least two different user access roles are necessary. Firstly the ownership/Administrator access able to delegate device control to other device or user access to other Master Authentication Device holders.

Each person will then be able to control communication devices and through them the specific master devices and slave devices.

In this setup customisation is easily done through prepared preferences triggered on authentication according to the device setup. For instance a small child is not required to do intelligent authentication, but is proximity authenticated. Bigger children can perhaps access everything but with reduced functionality (computers are not open for all sites and services, television can be restricted, etc.) and adults can have full control over all devices if they desire so (a Master device can drill down through the various devices controls to change the setting of the floppy disk drive to make it read-only or change the lighting system so that a specific touch switch triggers a Room atmosphere setting with three lamps, 22 degrees Celsius and the radio to classical music instead of simply be an on/off switch for two lamps)

In another implementation a TRUSTHW device is implemented to control the communication between any non-TRUSTHW device and any other entity. If devices internally are hardware traceable but device identifiable, the TRUSTHW device can link to the non-protected device and build virtual machines on the outside eliminating external linkability. Such a device could contain keys certified by Root Certificate keys but only allowed to use these for pre-defined uses.

The TRUSTHW device creates a trusted key with the non-protected device and externally appears to become the device. The Privacy aspect can be used to handle any type of device even if they are not trust-enabled using a principle of man-in-the-middle and device pseudonymisation to prevent identification of the actual device.

Limited Security Solutions with Central Control

A particular application of this invention is any solution described where the device is protected against third-parties listening, but the control of keys is NOT transferred to the new Owner or a central entity has way to acquire control or copy of keys of end-user devices.

For instance instead of an RFID Owner authenticating Authenticity Check, this could simply include using a Group Authentication by a central key releasing the ePC-number shielded by the Random Session key.

This type of features makes this invention highly usable for military purposes such as espionage, secret tagging or tracking of people, devices, shipments or transportation vehicles etc. Especially because the device can appear to function normally until the central entity starts communicating with the device.

Other uses are commercial tacking. Even though the consumer might use wiretapping equipment to detect some communication with the device is going on, the consumer would have great difficulty in learning contents of communication and proving tracking is ongoing as nothing is revealed from the communication.

In itself this feature without ownership control would not prevent tracking by the informed parties, but it would prevent third parties from tracking the RFID, learning anything about presence of the tag and preventing copying the Tag by transferring information to any device imitating an RFID Tag. If the key changes every time, it would make it impossible to make multiple copies of the same Tag without detection because key synchronisation would loose track and authentications would fail—as such this would be highly useful even for standard protection against faking products etc.

Applications

Instantly Revocable Chip Card

The main application of this invention is the ability to provide a fully discardable and instantly revocable multi-application, multi-identity Chip Card which can support creating, maintaining, authenticating and maintaining non-linkable relationships each within its own continuum of linkability of related transactions, accountability and communication support.

The same Chip Card can include a Passport, a healthcare card, a credit card, digital signatures etc. all in a fully privacy enabled version ONLY limited by the explicit unavoidable linkability such as uses where the individual are identified and the information used in this connection and not necessary or against the agreement stored in a identifiable version.

This invention explicitly implements a solution to revoke even anonymous credentials and digital cash by blocking the card process rather than the credential itself. This enables using fully anonymous credentials with protection against identity theft or similar problems due to loss of the card.

Digital Relations

This invention makes it possible to create generic two-way and group relationships with any combination of anonymity, accountability and cross-protection.

For instance two strangers meeting can exchange contact information using Privacy Reference Points using either a direct wireless protocol or using a device to coordinate the connection. In addition to the default managed accountability solutions, the relationship can be pure two-way anonymous combined with a direct negotiated and confirmed exchange of PACCs (accountability with any combination of trusted parts or devices) or identification.

This is usable in all situations (even remote) where people meet and wants to establish connection according to the situation context. This include but is not excluded to conferences, meetings, dating services, auction sites, transport, public events, accidental meetings at cafes, in the street, etc.

A special and very strenuous case is the example of a combined online and real world group therapy of victims of sexual abuse. Attendees want to be sure that no one is anonymously collecting information about the others and deliberately trying to abuse this information. At the same time easy and non-identified authentication and convenience for remote access is important.

Privacy Marketing and Customer Loyalty

This invention creates the perfect support for what is known as the customer staircase—the gradual evolvement of a commercial or social relationship.

Leaving an anonymous connection point is absolutely safe for the customer and yet there is full support for communication, payment, receiving physical deliveries to be enabled at any later point in time. The social and mental cost of opt-in registration is therefore zero for the customer removing key transaction costs for the information society.

The customer in addition has 100% Opt-out guarantee, that he can always kill the relationship for any reason.

The basic setup is perfectly anonymous and from a legal perspective not transferring personal data from the individual to the store according to for instance the EU Data Directive. Subsequently customer data are likely NOT bound by the restrictions of the Data Directive, but can be considered 100% anonymous.

But still there is full convenience, trade support and communication channels availability. If the store can justify some sort of accountability, a PACC can be designed accordingly and still support any balance in the relationship. Building customer loyalty is therefore only a question of the store service, products and communication.

Life Management

In the combination of a Privacy Authentication Device such a Chip Card can provide complete and secure access to all relationships with the ability to determine the level of linkability by externals subject only to practical decisions such as communication convenience, cost and concern.

Without changing the user interface and convenience in use for instance healthcare related relationships can be fully separated from other parts of the Client life.

Instant Plug and Play for Devices

Client can acquire a new Device and instantly use this for accessing Client history by either upgrading this Device to a Privacy Authentication Device by incorporating the Chip Card into the device Chip Card Reader and cross-linking these or using an external Privacy Authentication Device to control the New device. Client can then either connect to a shared storage space for instance through a mixnet to access his personal data files or traverse relationships and collect relevant information for address books or more specific profile information depending on the type of device.

Infrastructure Session Authentication

A very important aspect of this invention is the ability to create communication devices able to establish convenience, availability and payments without providing traceable authentication towards infrastructure.

For instance a modified mobile phone can be turned on and authentication towards an anonymous one-time-only PRP. This session can be provided with all sorts of localised services such as location information, in-store services, ticket-based, ubiquitous device management etc.

The mobile phone can use the store information to publish the context-specific contact points (CPCP) making the users anonymously accessible for family, friends, work, groups etc. in real-time and always on.

By creating business-card access points (listed and identified telephone, email or similar contact information) and then creating mixnet reply-block combined with CPCP.

The same principles are easily tranferrable to other type of communication such as wireless networks (such as WLAN) and fixed-net networks (such as LAN).

Peer-to-Peer/Instant Messaging/VoIP/Chat

The invention creates a breakthrough in connecting decentralised access points without depending on a centralised entity in control. Two Clients in a relationship establish a shared relationship secret and a domain-reference. As long as they use the same algorithm, they can both create the same context specific reference (CPCP) relative to a domain reference and publish this only linkable to a one-time-only PRP.

The domain reference can be dynamic and managed by a group of synchronised peers together with a dynamic shared table of peers operating the domain. The domain operator receives a CPCP linked to a PRP and try to match this with other CPCPs.

When a match is found a link message is forwarded through the relevant PRPs link the two otherwise anonymous sessions. The two Clients now which relationship, they are connected to and can subsequently carry out a zero-knowledge authentication to verify this. The session can continue either on a direct peer-to-peer basis, through the PRP-providers or the session can be handed of to any other session support such as a dedicated router acting as a proxy doing explicit routing or address shielding.

The consequence is that the same relationship without increasing linkability can be used as entrance to both high-bandwidth protocols such as video conferencing, always-on protocols such as Instant Messaging, dynamic Peer-to-Peer such as Voice over IP.

IPv6

In IPv6 there is a naïve notion of one IP per device. In order to provide security it should be one IP per device per session or rather per PRP-session. By coordinate IPv6 with PRPs IPv6 can be upgraded to include privacy. Key is that authentication and accountability are independent aspects.

Grid

The idea of sharing computer recourses for renting of capacity and there by both better utilising existing computer resources and making possible massive parallel computing for instance for research projects are attracting a lot of attention. However, creating one virtual computer with direct access to all information is providing for massive privacy invasion and security breaches in all different aspects.

This invention provides GRID computing with a balanced solution by de-linking transactions and thereby decentralising control. The basic linkable services need to be client-side in trusted environments tightly controlled by the Client. However coordinating services, brokerage, PRP-providers, IM-providers etc. can make extensive use of GRID computing as they are characterised by the inability to abuse the information provided.

Creating Privacy Instant Messaging Across Interactive Services.

This is for instance highly useful for interactive television sessions with distributed Group Television. When the content is broadcasted and the television add an overlay with the customised part in another two-communication line, interactive television can be privacy-enabled.

For instance combining a PAD authenticated to a television session link to two-way relations with broadcast television. The content provider or a content service provider can host specific services and support the Client viewer in his use of the broadcast content. This is highly relevant for news programs, knowledge programs, entertainment etc. One can even imagine that the program has different impressions depending on preferences so that for instance Clients preferring happy endings to movies can get happy endings and other can get other endings. Similar programs can have various focus on the same subject so that for instance elements of programs can result to different tracks or content changing viewpoints, focussing on technical aspects or emotional aspects, more or less action, more or less romance etc.

In addition this opens for creating entirely new program concepts and interactive services where highly localised and customised interactive features interact with broadcast content such a game shows, quiz shows, discussions of issues related to the program, voting on issues, prioritising questions from the audience to interviews, providing input to direct the continuation of the program, rating programs etc.

This also creates a powerful linkage between commercial interests and broadcast media. Online or integrated product presentations can be directly linked to the audience purchasing products or just creating contacts requesting further inputs. This can be combined with program sponsoring and other sorts of trade promotion.

Instant Relationship can both be created Program specific (key equals Hash(relationship secret XOR Program specific key)), combined with ordinary instant messaging (Key equals Hash(relationship secret XOR Date/other non-program specific)) and a combination in the form of a call to participate.

A combination of a generic PLIM and a program-specific PLIM creates an entirely new way to enable fast audience attraction to interactive activities as this creates a virus effect. Each Client participant pages his relationships which again pages their relationships etc. This works seamlessly across communication channels, protocols, providers of infrastructure, instant messaging, PRPs and identity services.

One key component here is that it is non-intrusive. It ONLY works for Client that are actually online and has the IM and paging features turned on.

A Client can be virtually always on by proxy using a virtual service combined with a trigger to locate him. This trigger can be anonymised against constant tracking using for instance a mixnet reply block solution, broadcast or other non-traceable or hardly traceable solutions. It is noteworthy that the accountability issue is orthogonal to this as PACC can be linked to the proxy and a authentication is integrated in the connection phase between the two parties.

Privacy Rights Management (PRM)—Digital Rights Management and Content Distribution

The direct link between transactions and personal control also creates a privacy framework for Digital Rights management. Clients Acquire rights to some content linked to a PRP where encrypted keys are stored. This way acquiring digital content does not increase linkability and yet it is accessible from everywhere independently of channel or media.

One possible way would be to re-encrypt the content keys with device specific keys such as DVD-players, televisions, portable devices such as PDAs, portable or desktop computers or any other multi-media equipment etc. For high-value content dedicated versions of content can be created together with specific protection such as watermarking etc.

At any time Clients can replay content by collecting the encrypted decryption keys from the PRP, transfer this to the Privacy Chip Card and then decrypt the keys for the proper use.

In addition content can be prior distributed to a Content Service provider to shorten the broadcast time by distributing prior to certain events or utilising periods of less traffic (night-time) and minimising the repeat distribution of content over long and central connections. When access rights are acquired the relevant content specific key is created and encrypted with a private key controlled by the Privacy Chip Card combined with a generic reference and ticket to collect the content from the distributed net of Content Service providers. Clients can collect and store content locally, but can at any time connect and reuse the prior required content independent of devices and locations. Content can be available in multiple formats using the same keys so that acquire content can be replayed independently of device, channel and media.

Protecting Identity Providers

Any Client is assumed to use multiple Identity Provides and PACC according to personal preferences related to communication convenience, cost and linkability. By including an anonymised PRP-layer based on Chip Card-specific PRP in front of access to Identity Providers two major advantages are created. First the Client can block a specific card without linking the various identity providers. Second the PRP-layer will introduce a protection of the Identity Provider from the Infrastructure access provider (ISP, telco etc.)

Personal Inventory Management

Such a new device could for instance be a Inventory manager incorporating a combined RFID/Bluetooth, WLAN and microware reader able to communicate with all sorts of devices or product tags.

After purchase information about all devices and Product Tags with Digital Device Keys can be registered in a Personal Inventory. Using handheld or fixed readers (for instance at the house entrance) it is possible to keep track of all personal belongings and create personal inventory services such as maintenance (invoices, guarantees, service contacts etc), reminders (checklist when leaving the house, lending-lists etc.), where is this thing (glasses, keys, purse, books etc.), insurance related, theft protection (broadcasting shut-down or yell commands).

When lending a device to someone, a new set of Device Secret (DS), Group Secret (GS) and Device Id (GI) can be created and the keys shared with the person borrowing the device in such a way that the borrower cannot access the original keys. When issuing an authenticated kill commend this set of keys can be deleted. When issuing an authenticated kill command to the last set of Client keys, the device can be restored in its original state and continue its product life cycle as part of the recycling process.

Theft protection would simply involve enabling response without authentication. The owner broadcasts a theft authentication and reports the device identifiers together with contact information. When any reader picks up the device without authentication, the device is traceable and the owner can be informed. This form of theft protection would have the added benefit that ALL readers Will be on the outlook for devices that are NOT privacy-enabled and reporting these. When making non-privacy enabled devices subject to fines or penalty the initial privacy problem is reversed into privacy protection.

Privacy-Enabling Personal Accounting, Cost Accounting Etc.

Today most personal accounting is done through the balance side of the personal or family Accounts ledger (bank accounts) etc. not providing for the critical Profit/Loss statement describing accurately how the account period has changed the Client financial situation. Banks, credit card companies, Online Billing and Payment services are moving towards getting access to the invoices also. The consequence of linking identified payments with invoices is significant destruction of privacy and infomediary control.

Using Privacy Reference Points Client is able to anonymously traverse his own history of transactions and collecting the invoices etc. for accounting purposes. ONLY the Client is able to do this is a trusted environment such as his own desktop at home.

Similarly the linking of detailed invoices over product codes to the producer product information can provide basis of more advanced services such as cost accounting (calories, vitamins, allergies, general diet etc.), spending distribution on categories and sources (rich/poor countries etc.), but also provide for ways to distribute warnings from producers to customers with defect products, product updates or related information.

The account perspective is especially improved given the fact that this invention makes it possible to do dynamic linking of historic transactions in case new focus emerge. For instance the growing consumer attention of the issues of radiation of wireless communication and the energy consumption of electronic devices is likely to lead to changes in product information. Producers can update product information at home and consumers can access this information for historic transaction in exactly the same way as for new transactions after the information update.

Self-Service Shops

A very advanced application of this invention would comprise of self-service shops combined with anonymous credit, anonymous relationship support for loyalty purposes, just-in-time value chain support combined with theft protection with RFIDs. It can work like the following.

The Client authenticates on entry to a self-service show by authenticating towards the Service Provider and the Service Provider returning the encrypted shop specific customer number of the Client to the Shop Computer. This way a Client-specific and authenticated session is established between the Client and the Shop Computer for in-store communication services.

At point-of-sales (POS) of the Unique Product Identifier (UPI) of a product is collect from the RFID tag and transferred to the Client together with for information related to price, product and other conditions of the purchase such a guarantee. Client verify purchase and the purchase amount is authenticated using the anonymous credit protocol and deposited with the Service Provider combined with a

Privacy Delivery Coordination

This invention can easily be extended to support mail-order etc. as for instance delivery and brokering same-time release of payment and product can be coordinated through the PRP-provider. Zero-knowledge authentication related to drop-points and dynamic late addressing where the shipper receive information of the final drop-point AFTER the product has left the producer is achievable using the principles described in “Establishing a Privacy Communication path”, xx.

One valuable application of this it the ability to create cheap electronic stamps with integrated protected addressing using RFIDs. Envelopes can be created with integrated tags which can be modified to both the proper pricing and receiver-control of addressing (to drop-points etc.).

It should be noted that the zero-knowledge protocols presented as part of this invention is even stronger than in the above invention in a number of ways providing means to protects against some very advanced attacks such as the Shipper trying to trick the Client into verifying receipt of one parcel where he is in reality receiving another.

Trade Brokerage

It should be noted that this invention provides a very advanced and innovative extension to the above patent application in the fact that this invention does not rely on an identity provider to create transaction support. This invention therefore provide the ability to create truly anonymous support for same-time release of payment and product in both in-store, mail-order, and for instance for advanced auction applications.

Hosted CRM and SCM

This invention provides the means for very advanced outsourcing of support for customer care and supply chain processes. In principle the store does not have to have any internal IT except linking to the PRP-providers and professional services (call centre, financial management, sales/marketing etc.) for customer care and combine this with providers of logistics and purchase services to support product procurement.

It is easy for the any skilled in the art that Privacy delivery can be extended for multi-step value-chain support.

Multilevel SCM and CRM

A very strong application is that this invention supports the ability to link the entire value chain without changing the relative power distribution. The store can connect suppliers with customers without risking suppliers trying to reach consumer directly. In other words the store customer database is protected from abuse and still the store is able to make full use of supplier interest in providing value added services and support to the various products. This can even include mass customisation or tailored products made to order.

This can be done in at least three basic ways. The easiest method is the direct where the PRP is considered a group relationship between the Client Consumer and the store as the main parties and store suppliers as sub-relations with access control by the store. The store can further arrange for re-routing using inhouse pseudonymisers so that suppliers appear as part of the store organisation. Using a principle of tickets each purchased product can be turned into a direct relationship connection with the provider under full control of the Client. This last solution would however likely lead to disruption of the value chains as producers would gain direct contact with end-users outside store influence and control.

Adapting Device to Device Authentication

Washing machine group authenticate all clothes and then authenticate each individual piece of clothes to identify washing parameters and protect against wrong programs etc. Clothes can be linked to Ironers etc.

Instead of authenticating the product tag can be adjusted to the specific appliances through the PRP-link to the product supplier. Each piece of clothe could store only the washing machine information (colour, temperature, other aspects) without storing any product identifying information. This reduces the risk and complexity. Also it ensures backward and forward compatibility of the device to device authentication if only the product tag can be updated and the (PRP) link to the product supplier is established.

For instance a Client can contact the producer of clothes or food with the specifications of the version of the washing machine or refrigerator. The product information can then be formatted according to the specific appliance device to provide a simple interface as an extract from the detailed for instance XML-formatted product information. In other words the product owner can maintain and update a product inventory with more detailed information that is made available in the product tag for day-to-day operations.

RFID Tag Product or Product Authenticity—Social Responsibility Etc.

The ability to remotely authenticate a cheap tag without sharing the keys for anyone else is highly usable for any application where authenticity or recognition is important.

An aspect of RFID Tag product authenticity is where a third party certifies certain aspects towards the end-user or any other participant in the value chain.

For instance a third-party verifier can act as an Authenticity Supplier and at the same time certify that no use of child labour has been employed in products produced in third-world countries. The Supplier cannot credibly claim this, so a Consumer would be in better position to trust a third-party. The third-party would need the authenticity check to remotely verify that the product is indeed originating from a production process, they have checked.

The same aspect of third-party verification would be highly useful for public inspection such as customs or anti-terror inspections checking that the product has gone through security and import check, healthcare applications with a doctor agent verifying medication towards a prescription or customised/individualised medication where a dynamic key is deposited on the Tag at point of production to be used in for instance a gene therapy programme tailored to the specific patient DNA.

Road Pricing/Ticketing/Public Transport Payment/Car Parking Etc.

A very advanced solution would include a combination of even simple RFID-tags with multiple different Group Authentication specific to for instance public transport, car parking etc.

Each Group Authentication key would upon a Privacy Device Authentication release a PRP-reference pre-encrypted with a public key of the provider of services (e.g. transport company) together with an authentication pre-encrypted for the Service Provider of the PRP. The provider of service would then forward the message to the PRP who upon authentication would release pre-encrypted tickets, tokens or payments

For tickets working for a time period, the RFID can easily be modified incorporating this period when comparing the timestamp so that it will release a link to the already authenticated ticket until it receives a Group authentication attempt with a timestamp outside the specified time period. There can be an overlap for discounted extensions. But eventually the RFID-tag will act as if the Group authentication is just a new ticket request and act subsequently by responding with the next PRP.

In case the RFID-device is lost, the Client can block all related PRPs and transfer the tickets to a new RFID-device. Client can update the RFID by Device Authentication the root device key are transfer updated prepared PRP. A more advanced solution would be a ring principle where each PRP upon authenticated would respond with the next PRP to save space on the RFID-tag.

Incorporating the Anonymous Credit Principle would further mean that tickets can be both pre- and postpaid without altering the convenience and privacy properties.

This means that even cheap and simple RFID-tag based on proximity and automated ticketing can be fully privacy-protected and even anonymous without introducing any cost related to convenience or risk of abuse.

Using more powerful Client solutions the full range of services can be enabled including web surfing using the transport (bus, train, plane, ferry etc.) access points with suitable PACC negotiation, buying new or paying for old tickets using Privacy Credit Card Payments, Digital Cash, Anonymous Credit or other types of payment.

Combinations are easy extensions such as for instance a Conference Registration Ticket with customised meal tickets, sub-events, car parking, pre-paid or discounted public transportation combined with establishing relationships with selected conference attendees using a pre-prepared list of PRPs with related profile information. In addition to the integrated accountability and contact information, profile information can include publications, company information, product information, requirements for demanded services and products, project description.

International HealthCare Passport

A very important application of this invention is the introduction of a portable HealthCare Passport enabled across national borders where emergency units (hospital, ambulances and even first-aid support staff at for instance sports events) anonymously can group authenticate to access the basic and vital Cave healthcare information related to allergies (towards anaesthesia, antibiotics etc.), heart weaknesses, diabetes, infections diseases (HIV etc.) and other information to the specific person in question such as health insurance etc.

Since the Client (patient) can be indisposed this information is to be non-identifying and positioned outside the basic Client device authentication combined with alarms and means to ensure follow-up on any attempt to access this information.

By further enclosing entry-point to contact the Personal Doctor or dedicated emergency support functions in the patient home country supplied with means to provide further access to the Personal Doctor or other with access to the specific patient HealthCare files this invention provide the solution on how to gradually escalate access to sensitive health care files without risk of unjustified privacy violations.

Similar entry-point to contact family members in case of emergencies can similarly be stored here.

This solutions is still fully discarded as the information provided is anonymous and not in itself abusable, there can be tight PRP-supported control with any attempt to access this part and the setup is fully revocable as the reply-blocks to create access to doctors and relatives can be stored encrypted with the PRP-provider and deleted without having access to the Healthcare passport itself.

International Passport with Biometrics

Another key application of this invention is the ability to provide privacy-enabled and revocable solutions for strongly identifying international passports with biometrics case linkability to the individual. Key is that the Passport Chip Card contain biometric templates encoded with one-way protection. To authenticate the Chip Card holder has to be able to reproduce the matching information to access the signatures verifying identity.

Both Identity and biometrics and be verified against block-lists in a safe environment without registering biometrics or identifying information for citizens travelling. In addition the PRP related to the entering a national border can be use as a natural ticket for the travel and provide linking for the exit and include accountability to establish verified identity in case terms of exit is not meet.

Since the PRP-support provide instant chip card specific revocability the ability to copy and abuse unvoluntary access cards is close to eliminated.

Further alarms and controls can easily be introduced for any such sensitive authentication for instance by combining this with transmitting information to the card holder himself the card or using travel credentials to citizens similar to the anonymous credit scheme to ensure that all travel is accounted for without thereby implemented a tracking of the individual.

Abuse in this setup is therefore primarily limited to the quality of biometrics in itself and the ability to establish passports linking one set of biometrics with another identity which is basically a problem related to the issuing authority which will then be traceable. A way to detect such organised abuse would be to include statistical verification of passports from various issuers based on random linking of verifiers and issuers to prevent organised collaborations.

Referrals

Doctors referring to further investigation at for instance x-ray etc. can be done through context-specific pseudonyms and tickets. A patient can go to a HIV-test and have it made without identifying towards the HealthCare person. DNA biometrics is NOT ensured this way and actual tissue and other organic samples has to be treated with care not to get directly linked with any digitally identifying information.

Electronic Voting

A very advanced form of electronic voting can be enabled by combining PRPs with credentials. PRPs are inherently anonymous unless they are linked to a PACC and credentials are by nature anonymising which make the entire vote anonymous.

All citizens can receive a one-time-only credential for at specific vote event. Each credential is non-transferable if lock to a digital signature.

Using any Privacy Device Authenticated communication device, the citizen can establish an anonymous connection and use his credential to enter the voting booth where he can then vote anonymously.

This can be combined with entering a physical boot so that nobody can be forcing the voter to make a different vote than the voluntary and best informed democratic vote. The purpose of this is to protect against forced or traded votes.

To protect trust towards errors in vote counting, each vote can be published with a reference for instance created as a hash of a random pin and a non-linkable part derived from the credential. By comparing the total number of votes with the number of credentials, the vote can be protected from vote spoofing and each vote can be verified by the citizen, who made the vote.

To protect against blackmail or other forced alterations of votes, the voter can be equipped with means to fake any vote. One way would be on request in the voting booth to generate both the normal vote and a full set of false votes displaying different pins for each vote together with adding a counter for the vote administration to subtract a vote from each possible vote.

To protect against blackmailers aware of this to force the voter to demonstrate two votes for the same option, the voter should be able to request an arbitrary number of full sets of votes. The voter can thus in addition to the real vote always generate the same number of fake votes as required. The blackmailer will thus not be able to control the real vote. In real life this is a rare problem, schemes like these are primarily to prevent the blackmail to be initiated in the first place because the outcome cannot be enforced.

The voter can then without indicating which vote he was supposed to make mentally note down the pin and thereby plausibly claim any vote. He will however still be able to verify that he voted for the correct candidate and the voting officials can verify that votes are EITHER single (normal votes) OR a single votes combined with a full set and a subtraction counter.

Device Theft Protection with GPS Response

The basic principle of zero-knowledge device authenticating a device provides the perfect solution for non-privacy invasive theft control. When a product of value—such as for instance a car—is stolen an authentication towards the device theft control can be broadcasted over any protocol such as radio, mobile, WLAN, Bluetooth and especially on selected relevant hotspots such as petrol-stations, ferries, car parks, border crossings etc.

When the theft control is locked with the car start authentication device control which is again deeply integrated into the engine, use of a stolen car can be made impossible and removal of this control similar almost impossible.

The theft device control can be supplied with a cheap GPS-receiver tracking the location and thereby reporting the physical location of the stolen device ONLY in case of theft. In any other situation this invention will have no negative privacy or security side-effects.

But even without a GPS tracker a theft authentication can mark the device stolen and also make the device unusable.

Locating Children (In Zoo Etc.)

The dark room solution (Café, Disco, conference, event)

When entering an event, a link to the event community is provided.

A newcomer create a Node (PRP) for the Event Community and create the event specific personal address book as a selection from his general address book and create event-specific zero-knowledge Relationship Authentication Requests (RAR). These are based one a shared key which is shielded with the event specific key (for instance DS(event)=DS(Relationship) XOR Event Key).

He checks if any of his Relations are present already by verifying requests against his event-specific address book.

He then stores call for Relations for new arrivals after his. He can also create for instance Call for Contact or just leave Event-specific profile and contact information for historic use.

When leaving the event, he removes his stored Relationship Authentication.

Applications: Large crowds (any of my friends here? Where is x that I was supposed to meet), Large distance (where is my child? Request contact—auto/consent-based reply)

Privacy Instant Messaging and anonymous Contact information for anonymous communications channels

Money Anti-Counterfeit

Plans are emerging to use RFIDs in money notes to protect against counterfeit money.

This invention provides an advanced solution against counterfeiting that is at the same time privacy preserving. The group authentication code combined with a number of non-linked references can be use to create any desired property of counterfeiting which can be both off-line, online or a combination.

The off-line version can simply be implemented by money issuer to sign the hash combination of a series of random references, a unique note number and the monetary value of the money note and store these together with the reference number. The note specific Device Secret can be a unique note number requiring visible access to the note. Since the Device Authentication is providing a shielded session secret R only the verifier can carry out the verification. These can even better shielded by more complex algorithms.

The online version is more troublesome as this can lead to tracing of notes. This can be solved using anonymous and non-linkable transactions. Each note have a number of non-likable one-time-only PRPs providing a check for counterfeit and especially protect against copying the RFIDs.

This could include removing the unique note number and instead use the same Group Authentication Code for a larger selection of money notes.

Another element would be to combine this with a revolving method so that each PRP contain authentication and encrypted information about the next PRP. This information is transferred to the RFID. If the RFID-note is a copy then the copy would invalidate the original as only one string of PRPs could work at the time. In other words accessing and splitting the RFID of an original would not provide multiple PRPs to make multiple copies.

A further advantage is that taxes etc. can be collected as part of anonymous transactions and thereby reduce the administration for companies and trace of citizens and companies.

Money Loundering

It should be notes that in the preferred setup the electronic payment system in this invention has a built-in anti-money-loundering scheme in the closed loop monetary-system—money is transferred to/from bank accounts and only entering passing through one transaction where taxes etc. can be ensured.

This scheme assumes that cost of transferring money to and from banking accounts is only covering the real cost—otherwise the anti-money-loundering scheme can be abused by banks to create an artificial fee structure with abnormal profits. In such case recirculation of electronic cash should be used to create a free cash flow until abnormal fees have been removed from the pricing structures.

Protection against money-laundering of physical cash is more troublesome as this can include requirements for tracing the note from owner to owner and thereby creating total linkability of cash transactions. Without protection against money-laundering nobody should be able to recreate the series of PRPs related to the same note.

To enforce protection of money-laundering, one both have to create linkability of PRPs AND enforce sufficient number of checks for counterfeit etc. to investigate the transaction flow. One way to do so would be to implement ownership control of the physical money note through the RFID-tag using the principles described in this invention.

Ownership control through the RFID-tag would also provide the benefit that physical money could not be stolen and create huge resemblances between digital cash and psychical cash perhaps even to the point where using physical cash would not provide any benefits.

Surveillance Cameras, Microphones Etc.

Devices such as cameras, microphones etc. can be equipped with a built-in rights negotiation so that if any Client is nearby refusing any recording due to privacy issues, these are shot of and both show this in a physical way (something blocks the view) and digital by stating stand-by.

If the devices are there for security of either people or assets, Client can be acquired to authenticate by leaving a non-linkable accountability proof. This can even be combined with a built-in deteriorating as time goes by and no problems are discovered.

IF—and only if—Clients does NOT authenticate according to context Cameras can turn on. By encrypting the content using keys according to privacy principles meaning external and multi-steps needed to get access to decryption keys, abuse outside democratic control can be prevented. These kinds of Privacy protection should be required and verifiable.

For use of recording devices in the personal and ubiquitous space such as Mobile phone Cameras, recorders, microphones etc, strict permission has to be acquired BEFORE devices can start recording.

By linking these devices through PRPs to Event-linked PRP all recordings etc. can be instantly and permanently reachable by all participants documenting events for the future.

A special application of the above is the ability to combined road-pricing and speed tickets without invading privacy related to location etc. When a speed limit is broken and the car is connected to road-pricing ticket drivers can receive a warning first or be directly fined and immediately charged. The Proof of the offence can be stored in an encrypted form that only the driver can open. In case the driver later refuse or wants to appeal the speeding ticket, he can voluntarily open the proof for further investigation.

Linkability can be created according to the offence so that mild tickets are not linkable, but significant speed-driving require the creation of signed acknowledgement of speeding.

If the driver refuse to create linkability or to accept the fine, then and ONLY then the proof is stored and available to the relevant authorities. This can be further combined with the road pricing programme to block further access.

Privacy Preference Coordination and Ubiquitous Information Coordination

A very important application of this invention is establishing privacy control of the ubiquitous, ambient intelligent and semi-public spaces.

Any sensor recording information that is potentially abusable can automatically require receive accept from any person present even to initiate recording. Since this accept can be time-limited this can be propagated to the recording to be deleted or the decryption keys to be deleted after a certain time-span.

A specially valuable feature may be an option to pre-accept recording and retaining the option to delete the recording AFTER the event based on either a passive (deleted if no confirmation after the event) or active (recording is stored unless the person requests so).

A very valuable add-on is the ability to establish asymmetric links for everyone with a natural interest in the recorded material such as a recording of a discussion, a picture, a video etc.

In the authentication process the sensor devices receive one-time-only references to each person present. By storing here information about the sensor, references to the recorded material and information on how to access the material, each person present can in real-time or as long as the recording is stored access the material for personal use.

One additionally relevant feature here is that each person has a different reference to the recording as this is relative to the event itself, but not just globally available. Each participant has a separate PRP to link to the event and the reference is thus established relative to the participant-specific PRP for instance in the form of <PRP-reference>.<Recording-reference>, where <Recording-reference>is only context-unique for instance as a number sequence reused among all events. In other words knowing the Recording-reference without a relevant PRP does not provide linkability or access.

Recordings from any gathering of people can as such be instantly shared among participants which is highly useful for social events (e.g. parties, interesting discussions, etc.), academic (conferences, brainstorming, problem analysis), education (in classroom discussion, remote access), commercial (e.g. any agreement, meeting, exhibition etc.), public (e.g. negations with tax officers etc.).

This could for instance be highly valuable in the case of phone-based ordering of goods and services. Voice recordings are biometrics and identifying. Therefore recordings are link information destroying privacy—at the same time there are situation where a recording is valuable to validate what was the actual agreement in case of dispute. An acceptance could be to accept recording on two conditions—a) When the deal is over and all obligations meet the recording is deleted and b) that the recording is encrypted using keys from both participants so that no party can access the recording without the approval of the other party.

Another scenario is an event where someone takes a picture and this picture is both in real-time and post-event available to any present to remember.

Legal and Standards Issues

RFID and other wireless device components can by law be disallowed to reply without authentication to protect privacy.

Combined with this invention Stores interests are aligned with consumers and producers. IF an RFID, Bluetooth or other device is detectable without dedicated authentication upon exit from the store means one of two things—EITHER the product is being stolen OR some product does not apply to basic privacy standards meaning the consumer is not protected AND both the store and the producer has no digital support for the established consumer relationship.

In case of theft for instance doors should block combined with an alarm. The product is easily locatable as it itself tells both which product it is and where it is.

In case of a product error, this is customer service and the producer should be notified and perhaps even be charged a fine for violating privacy and damaging shop customer relationships.

Zero-Knowledge Device Authentication: Privacy & Security Enhanced RFID Preserving Business Value and Consumer Convenience

Stephan J. Engberg, Morten B. Harning, Christian Damsgaard Jensen

Abstract—Radio frequency identification (RFID) technology is expected to enhance the operational efficiency of supply chain processes and customer service as well as adding digital functionality to products that were previously non-digital such as, e.g., washing machines automatically adapting to the clothes put into the machine. However, consumer response clearly shows significant concern and resistance related to consumer tracking and profiling as well as problems related to government tracking, criminal or terrorist abuse etc. Multiple conferences warn that RFID take-up likely depend on solving the privacy and security problems early. These concerns are not adequately addressed by current technology and legislation.

In this paper, we present a model of the lifecycle of RFID tags used in the retail sector and identify the different actors who may interact with a tag. The lifecycle model is analysed in order to identify potential threats to the privacy of consumers and define a threat model. We suggest that the in-store problem is more related to lack of privacy solutions for the consumer himself than for the RFID. We propose a solution to the RFID privacy problem, which through zero-knowledge protocols and consumer control of keys has the potential to ensure consumer privacy needs without reducing corporate value from utilising the potential of RFID. We propose that securing RFIDs will require a physical redesign of RFIDs but that this can be done without leaving security and privacy issues to consent or regulation.

Index Terms—Privacy Enhancing Technologies, Radio Frequency Identification (RFID), Security, Zero Knowledge Protocols.
Stephan J. Engberg is founder and CEO of Open Business Innovation, 2800 Kgs. Lyngby, Denmark (e-mail: Stephan.Engberg@obivision.com).

Morten B. Harning is with Open Business Innovation, 2800 Kgs. Lyngby, Denmark (e-mail: Morten.harning@obivision.com).

Christian Damsgaard Jensen is with the Department of Informatics & Mathematical Modelling, Technical University of Denmark, 2800 Kgs. Lyngby, Denmark (e-mail: Christian.Jensen@imm.dtu.dk).

Introduction

In today's hyper-competitive business environment, companies are increasingly forced to reduce costs, rather than increase price, in order ensure return on investments. Studies have shown that companies spend between 12%-15% of their revenue on supply chain related activities [9], so supply chain efficiency has become a necessary condition for survival. Radio frequency identification (RFID) technology is expected to enhance the operational efficiency of supply chain management in both manufacturing and retail industries by embedding small silicon chips (RFID tags) in products or packaging [8]. An RFID tag provides a unique identification number (an electronic product code or an individual serial number) that can be read by contact-less readers, which enables automatic real-time tracking of items as they pass through the supply chain. Depending on the RFID tag it may contain addition storage for application specific use (such as product descriptions, certifications or temporary storage related to process support) or generic functionality embedded into the hardware (such as sensor interfaces, cryptographic primitives etc.).

Moreover, RFID technology is already used to prevent shoplifting and the tamper resistance of RFID tags (in the meaning it is hard to change the encoded number) makes them well suited to protect against counterfeiting, e.g., the European Central Bank is known to consider embedding RFID chips in the larger denomination bank notes for this purpose [7]. Finally, when RFID tags are embedded into artefacts of everyday life, they will enable a wide range of innovative end-user applications, e.g., in the areas of home automation and ambient intelligence environments. This only requires that the tag is left active after it passes the point of sale. Examples of such applications are: location service that helps find mislaid property, tags embedded in clothes may provide washing instructions to washing machines (thereby preventing the washing machine from washing a woolly jumper too hot) and an RFID reader embedded in the frame of the front door may warn the owner of the house if he is about to leave home without his keys/wallet/mobile phone. Such applications are likely to increase user acceptance of RFID technology and may create a demand for products with embedded RFID tags, provided that important privacy issues are adequately addressed. An enabled RFID tag allows anyone with an RFID reader, which is able to generate an electromagnetic field powerful enough to drive the tag, to identify the item and thereby to track the location of the item and (indirectly) its owner. This ability to locate and identify the property of ordinary consumers has already raised concerns, among consumer organizations and civil liberties groups, about privacy in RFID systems and may result in a general consumer backlash against products with active RFID tags, e.g., Benetton has already been forced to reconsider its plans to embed RFID tags in every new garment bearing Benetton's Sisley [11] brand name and Tesco (a UK supermarket chain) in Cambridge was forced to abandon their experiments with an RFID based “smart shelf” technology developed by Gillette [REF]. Lately METRO was forced to back down on already implemented customer loyalty cards with RFIDs due to privacy concerns [10]. Finally, multiple conferences, such as the EU SmartTags workshop in spring 2004 [22], have isolated privacy enhancing solutions as important to ensure end-user acceptance.

The most common solution to the RFID privacy problem is to disable (“kill”) the tag at the point of sale. While some RFID tags can be disabled at the point of sale, other tags, e.g., tags in library books or toll road subscriptions, have to remain active while in the possession of the customer. Another solution is to encrypt the identifier so that only the intended recipient will be able to read the identifier. However, encryption creates a new unique identifier, which allows the tag to be tracked and thereby the location of the customer to be monitored.

In this paper, we propose a solution that allows the tag to require an authentication from the reader and only return its identifier to anyone with a legitimate need to know defined as anyone able to authenticate accordingly. This authentication mechanism employs relatively cheap symmetric cryptography and can easily be extended to a group authentication scheme and asymmetric encryption. The rest of this paper is organized in the following way: Section 2 gives a short introduction to RFID technology, including applications, and privacy issues. Section 3 describes our proposal for zero-knowledge device authentication, which solves the privacy problem in RFID systems. Related work is presented in Section 4 and conclusions are presented in Section 5.

Consumer Privacy in RFID Systems

As mentioned above, the use of RFID tags in supply chain management and retail is expected to increase dramatically in the near future. In order to analyse the possible threats to consumer privacy, we need to examine the technology itself, the way RFID tags will be used and the actors (stakeholders) in an RFID enabled system.

RFID Tags and Readers

RFID-technologies consist of chips that can be very small and incorporated in all sorts of wrapping, cards or product themselves. They come in both active and passive versions where the passive versions utilise the energy from the radio beam of a RFID reader to get enough power to carry out simple calculations and respond with is normally a unique number. The unique number or ePC numbers are to be standardized and stored in a central database, which will provide instant access, but thereby also linkability, across locations and various readers. It is important to emphasize that RFID tags are normally considered as resource constrained, but that the most important limiting factor is price and that there is an important trade off between the price and the computational/cryptographic capabilities of the tag.

The term active tag is often referred to as tags with a power source such as a battery or part of a device with a power cord and as such having fewer restrictions on computational ability. However in the following the term Active means that Tag require or have required Active involvement of the Owner or bearer of a tag.

RFID Tag Life Cycle

An RFID tag, which is embedded in product or packaging, passes through many hands in an RFID enabled environment. In the following, we present the typical lifecycle of an RFID tag embedded into a consumer product and identify the typical actors in RFID systems.

The typical RFID tag lifecycle consists of four main phases, defined by the ownership of the product in which the RFID tag is embedded:
1. Supply Chain Management: the tag delivers a unique electronic product code (ePC) [18, 19,20], which replaces and surpasses existing bar codes;
2. In-store & Point-of-Sales; the tag may be used by the retailer to track and support consumer interaction with products and provide services and purchase support.
3. Customer Control & After Sales Services: the tag may be used by consumers as an enabling technology for ambient intelligence applications, after sales services may use the ePC to record product service record or protect against counterfeiting;
4. Recycling & Waste Management: the tag's ePC may be used to automatically sort recyclable material and will also identify manufacturer, type and weight of disposable materials (the manufacturer of a product that will eventually constitute hazardous waste may ultimately have to pay for its safe disposal, this closes the cycle).

In this paper we focus on the second and third phases and the privacy implications of keeping enabled RFID tags in products, e.g., in order to enable some of the advanced applications in Phase 3. However, it is useful to examine all four phases in order to identify requirements for an acceptable solution to the consumer privacy problem.

Actors in RFID Systems

The typical actors in the RFID system outlined above will be:
1. the manufacturer, who embeds an RFID tag in the product or the packaging;
2. the logistics and wholesale companies that transport the product from the manufacturer to the retailer and who rely on RFID tags for supply chain management;
3. the retailer, who uses RFID tags for automatic inventory, re-stocking and cash registers and who sells the product to the customer;
4. the after sales service providers, e.g., warranty repairs, who may use the ID from the tag to record product history;
5. the infrastructure service providers, providing for instance RFID name services to link the Tag ePc number to the Producer or Retailer database with detailed information related to the application
6. the consumer, who buys a product with an embedded RFID tag and who may benefit from novel new applications of RFID tags;
7. the waste management company, who may use RFID tags to automatically sort garbage and recyclable materials and to levy waste charges based on the nature and the volume of garbage collected.

The RFID lifecycle allows us to identify two important features that a privacy solution for RFID must support: transfer of ownership and multiple authorisations. Transfer of ownership means that the set of readers able to read the tag will change at certain points in time and multiple authorisations means that readers belonging to several actors may be able to read the tag at the same point in time, e.g., the consumer and the after sale service provider may both access the tags while the product is under warranty. These properties indicate that simple solutions based on a single shared secret will not be sufficient to enhance privacy in RFID systems.

In order to simplify the presentation, we focus on protecting the privacy of the customers in this paper. For instance there are few obvious privacy threats in the supply chain process, but there can be threats of industrial espionage or shipments can be made to impersonate another security cleared shipment through some of the man-in-the-middle attack scenarios discussed later. However, the proposed solution may be extended to protect the privacy of all parties in the obvious way.

Understanding Privacy and Security

In the following discussion we take an objective approach to privacy and security meaning that we focus on risks without considering trust or consent perspectives.

The reason is two-fold; first a risk elimination approach would integrate privacy and security discussion making objectively better privacy solutions; second in the area of socio-economics there is increasingly focus on privacy from a control (“power”) paradigm rather than a consent (“trust”) paradigm in order to describe the connection between behaviour and real threats.

The linkage is however not straightforward as perceived control by consumers can be very different from their real control. Also in some aspects individuals prefer to give up privacy in order to gain for instance recognition or their 15 minutes of fame. We will not try to discuss this further nor try to give an overview of the vast number of articles produced except assuming that the difference between perceived control and real control will reduce as consumers gets more informed. Also we assume that consumers want both control and convenience in a complex, subjective and likely also context-dependant balance¹. The optimal will therefore be to ensure convenience without reducing control.
¹ For a discussion covering many angles see for instance Demos, The Future of Privacy ([23])

As the paper will show, we do not see an inherent trade-off between these parameters—if only technology is designed accordingly. On the contrary if privacy is designed into the system most security threats are also taken care of. If privacy is designed into the system the consumer have no privacy argument NOT to share information or use RFID tags.

Consumer Privacy Threat Model

Consumer privacy may be threatened whenever the user interacts with a RFID enabled product, both pre purchase, e.g., when the product is in the user's trolley in the shop, and post purchase, e.g., when the product is carried around or when the user interacts with the RFID tag in the product.

In store Consumer Tracking

The process from the consumer picks the product from the shelf until payment allows consumer tracking, e.g., knowing what products have been returned to the shelf, when the total price of the trolley exceeds the consumer ability to pay, or the consumers pattern of movements around the store reveals a lot about the preferences and priorities of the consumer.

This does in many ways resemble traditional closed circuit TV (CCTV) surveillance, which means that the privacy threats are well understood. However, the logs of RFID tracking are significantly smaller than output from traditional CCTV cameras. Moreover, the RFID tracking logs can be directly processed by machine, which means that the threat to consumer privacy can be significantly higher in RFID tracking systems that traditional CCTV systems—provided the shop is able to link the RFID to an individual customer. It is therefore important to prevent the shop from keeping persistent records traceable to an identified consumer of in store RFID tracking.

We believe that this problem is similar to the issue of location privacy for mobile phone users. The main point is that this is not a problem of detailed information being collected or stored per se, but a problem of tracking the consumer himself and thereby making the information abusable creating privacy risks. Both problems must be solved by using privacy enhancing technologies to pseudonymise or anonymise the consumer in the shopping process itself. One way to do this is discussed in Privacy Authentication—Persistent non-identification in Ubiquitous Environments [3] and the broader infrastructure support [14]. We do not consider the issue of consumer PETs, we simply assume that these exist or that the consumer pays using either physical or digital cash and have total discretion to decide on transaction linking². RFIDs would thereby only be traceable to the transaction/invoice or perhaps even an anonymous/pseudonymous customer number, but not to the specific identified consumer. In other words, RFID only adds to already existing privacy problems in this phase. To ensure security and privacy in digitally supported retail transactions, these problems needs to be addressed separately by other PETs such as Digital Cash and redesign of communication etc.
² It should be noted that we don't see an inherent trade-off between convenience and security/privacy as long as the consumer has control and each decision is implemented with the minimum necessary level of linkability. See the discussion under related work.

Post Purchase Use

After a product with an active RFID tag has been bought by the consumer, it will continue to interact with both the consumer and active RFID readers in his environment—these readers are not necessarily controlled by the consumer, but could be part of an eavesdropping or man-in-the-middle attack creating consumer's privacy risks.

The current RFID standard infrastructure is highly centralized requiring a central database to translate the unique number (e.g. ePC) to the location where detailed information about the product is stored. In other words whenever the unique number is available to any reader, the reader can in collaboration with infrastructure link the presence of a tag to detailed tag information and to the purchase transaction. By definition revealing the unique number in open communication presents the ability to establish easy linkability among databases creating serious privacy threats. It is therefore important that the tag is able to enter into some form of privacy solution, which prevents the store and infrastructure from tracking the product once it has been bought by the customer.

Consumer Security Threat Model

Privacy threats often also present a security threat to the system application. If a corporate database contain identified information related to a consumer, this is vulnerable to hackers, errors, information selling, criminals searching for potential victims, government confiscation etc.

Broadcasting or automatically revealing any persistent identifier is in itself a source of security threats, e.g., it is not a good idea to equip a soldier in a war zone with an active RFID tag, because it could be used by the enemy to track the soldier's unit or to trigger a bomb that could even be targeted to a specific soldier. Similarly, a consumer can be tracked exiting and leaving various shops linking the various transactions or providing a target for criminals, government or executive authority tracking or other abuse.

The combination is worse. If a potential attacker can access some database with any means to access RFIDs related to targeted persons or devices, he can then feed this information into any application equipped to monitor for such RFIDs. A simple example is tickets for a specific event or car road pricing schemes using unsecured RFIDs—the attacker knows that this specific RFID will eventually pass by a specific location and be easily detectable. Also wireless communication can be eavesdropped upon from a distance.

Other security threats are even more dangerous for criminal or terrorist abuse. For instance when RFIDs are deliberately used as passive proximity tags for convenient identification, access control, and payment or ticketing, there is an inherent risk of man-in-the-middle attacks. Unless there is special protection, any Challenge/Response protocol with an automatically responding and passive entity presents not only a threat to privacy, but also an open threat of impersonation or identity theft. A simple way to do Identity Theft is to use two RFID readers that are able to communicate with each other, thereby simulating the chess-players problem. The first RFID reader catches the Challenge and relay the request to the second RFID reader presenting the Challenge to the victim. When the victim returns the correct response, this message is then transferred to the first RFID reader who impersonates the victim and gets clearance.

Depending on the system application, this can present an unlimited risk such as for instance impersonating a security cleared person in an airport, authenticating signatures to payments/loans or even worse a person cleared to authenticate new fake identification papers or access to sensitive information.

In particular, applications using passive RFID-chips as proximity tags implemented under the skin present some seriously dangerous identity theft scenarios and these are already today available in commercial applications labeled as “security”.

The RFID security and privacy challenges are significant. We need solutions that prevent the RFIDs from broadcasting identifiers and we need solutions to the issue of vulnerability to linking through infrastructure.

Zero-Knowledge Device Authentication

Existing proposals for privacy protection in RFID systems [6, 15] focus on either legislation that limits a company's ability to collect personally identifiable data or technology to deactivate the tag (kill it) when the ownership of the product is transferred to the customer. However, solutions based on consumer consent offer no guarantee for privacy protection and often turn into some sort of advanced blackmail, where a desirable service will only be made available to consumers who agree to the collection of personally identifiable information. Deactivation of the tag at the point of sale ensures the privacy of the consumer (if the tag is properly killed,) but it prevents natural post-purchase services such as warranty, access to product support, authenticity, recycling and waste management, advanced home applications, advanced recycling and waste management and all the other applications in the two last phases of the RFID-tag life cycle.

Finally, a number of technologies have been proposed to protect the communication between tags and readers from eavesdropping, but common to most of these proposals is that they require a trusted infrastructure, which excludes applications where authorised third parties may be given access to the RFID, e.g., toll passes, transport cards for public transport, ski passes, etc. We review these proposals in our related work section.

As indicated above, different actors should be authorized to read the tag at different times in the tag life cycle, so it is important to differentiate between first the Consumer controlling the RFID post-purchase, the in-store purchase process and the use of RFID as a proximity solution such as a ticket. The main focus is on the post-purchase problem to eliminate the trade-of between convenience and security by ensuring the device owner control of information leakage.

We propose to change the design of the RFID tags, so that they upon entering into the post-purchase phase support the ability to change into Privacy mode where they only accept zero-knowledge device authenticated requests, which ensures that RFID tags only reply to authorised requests.

The central property of Zero-Knowledge authentication protocols is to prevent an eaves-dropper and infrastructure from learn about which entities are communicating and make it significantly harder to do brute force attacks on the protocol. The Owner shall be able to communicate with the tag without leaking identifiers. The tag must be able to authenticate the reader BEFORE it returns any identifier or response that can reveal tracking information.

RFID tags with limited computational resources cannot handle advanced cryptography, but they will be able to perform basic operations like XOR and hash functions which can be handled even in the cheaper versions, but not in the cheapest Read-Only RFID Tags. These operations are sufficient to support the device authentication protocol proposed in this paper.

In the following, we present the basic zero-knowledge device authentication protocol and describe a few scenarios where the protocol may be applied.

Basic Zero-Knowledge Device Authentication Protocol

We propose a basic zero-knowledge device authentication protocol designed for resource-constrained devices, such as RFID tags.

The core zero-knowledge authenticated request is not generated by the RFID reader itself, but by an actor using any device under his control, which is able to generate a request which is then forwarded to the RFID reader and communicated to the RFID tag. Upon proper authentication the TAG will respond in a similar manor to the RFID reader which returns the reply to the actor, who can then initiate the next step. This can be simply detecting the presence of the specific tag and do nothing or instructing the Tag to do some operation such as revealing the ePC to a retailer. Normally we would however assume that the actor device itself will handle communication towards third parties and the tag itself only communicates with the actor device ensuring the ePC is NOT stored on the tag.

The reader and device can of course be the same such as a PDA that is NOT revealing any persistent device identifier. In the following we assume for simplicity that the actor is the tag owner equipped with some sort of PDA with inventory management similar to an address book and the ability to communicate accordingly.

It is noteworthy that this approach explicitly is open to broadcasting and message relaying, but only when the actor is actively involved in the authentication process.

An important aspect of the zero knowledge property is that the tag itself is not tamper resistant. A security parameter is that the ePC number does not have to remain stored on the tag and the ability to identify the tag is therefore transferred to the owner. In other words—the tag itself does not need to know the real secret which is the identity of the tag. The shared secret operates as an indirect identifier which only the actor can translate into meaning and only the Owner can translate into tag identification

The generic approach to authentication with this serious lack of asymmetric or symmetric primitives is based on two main aspects with three variables; A non-encrypted nonce is used in combination with a shared secret to communicate a second nonce. Verification of the knowledge of the shared secret is then based on an operation involving a combination of the second nonce and the shared secret.

For the specific application of RFID we use the one-time-pad aspect of XOR and the one-way aspect the hash algorithms as the main security properties.

Our specific suggestion for the core RFID authentication protocol incorporates additional security features. The Actor authenticates to the RFID-tag by sending a Zero-knowledge Authentication Message (ZAM).

The format of the Zero-knowledge Authentication Message³ is:
³ Variations of the basic idea are straightforward and will Dot be considered here.

Authentication: [DT; (RSK XOR Hash(DT XOR SSDK)); Hash(RSK XOR SSDK)]

In the above DT is the first nonce, RSK is the second nonce and SSDK the shared secret.

We propose to use the first nonce (DT) to prevent replay attacks. After each successful authentication DT is stored by the RFID tag and authentication attempts with counter values below or equal to this stored value will be ignored. Therefore we propose to use a Date Timestamp (or any solution with similar properties). A request is ignored if the DT of the request is smaller that the DT of the last authenticated request⁴.
⁴ Using a DT introduces the problem of clock synchronization among all the readers, but this can be solved in the usual way.

The second part provides input to make the RFID-tag able to recover the second nonce or the random session key, RSK.

The third part of the ZAM allows the RFID-tag to verify that this is a valid authentication. Validation of the third part provides an authentication proof that the authenticator knows the shared secret device key. This step is a vital novelty as it makes it possible to authenticate a valid Actor BEFORE the tag even responds.

The shared secret device key (SSDK) must be known by the specific tag and authorised Actors. Proving knowledge of the SSDK is necessary and sufficient to authenticate the reader, while the tag being able to reply is necessary to authenticate the RFID-tag towards the actor but NOT to anyone else.

It is important to note that the RFID tag will only respond if the authentication validates successfully as it would otherwise leak data about presence even though this might not be an identifier. To prevent against fake acknowledgement an acknowledgement is also zero-knowledge by containing a function of the shared secret such as a hash of the concatenation or XOR of the random session key, the shared secret and the nonce date-time stamp.
Tag response: [Hash(RSK XOR SSDK XOR DT)]

The outcome is that the Actor can communicate with the tag without revealing identifiers of the tag or the device in the protocol. The Actor can for instance release the ePC value stored in the inventory management in the PDA by letting the RFID reader impersonate the tag according to the ePC standard, i.e. without any change to the ePC protocol.

The zero-knowledge property of this solution is that—even though the protocol itself is a identity-secured shared secret protocol and as such might not abide perfectly to the traditional understanding of a zero knowledge protocol—the underlying property is that the tag does not even need to know the real tag secret which is the identity of the tag, its owner or any other external reference.

Augmented Protocol

The device authentication protocol can in itself act as a toggle switch (turn on theft alarm, open door), a locater (respond with presence) or a session initiation (respond with presence plus await command). Here DT could be used as a session identifier.

Application specific commands could also be added as a fourth parameter for instance as in a hash/XOR combinations with RSK or simply as a relative commend (“use key 4”—see below) to support tag efficiency.

Additional security features could be added but only on expense of either storage, energy consumption or adding complexity in the vital key management;

Backward secrecy can be incorporated using the RSK in a hash combination to change the SSDK on a per session basis. This would also incorporate Forward Secrecy unless an attacker is able to eavesdrop on every session. This would require careful attention to key synchronization.

The tag could incorporate multiple SSDK in parallel of which several different types can be identified; Access level for tag modification, Group Authentication with Category Data, Group Authentication in Trusted Environment and Tag Identification and Group Authentication in Untrusted environments WITHOUT tag ever gets identified.

For instance the Owner can add new or temporary SSDKs or change the overall tag mode back to ePC. This would either require the device to traverse through multiple keys requiring energy or to reduce the energy drain require building in a relative key reference to help the tag chose which SSDK to verify against.

The issue of Group Authentication of sharing the same SSDK between multiple tags and/or multiple Actors depends on the application and especially on whether the Actor is trusted (i.e. another device of Owner or for instance belonging to the same Group/Family as the Owner).

Foreign Actors with SSDK keys to a consumer tag represent a basic threat both to the zero-knowledge property and to security as such. Without ignoring that many applications can be of this nature (e.g. Product Authenticity), solutions to this group of problems require new solutions to Identity management or Agent Support which is outside the scope of this paper.

For the rest of the paper we assume that the RFID tag even if physically broken does not store identifiers that can be traceable to the consumer by third-parties. All keys and references are generated by the consumer and can be randomly changed.

Even if the tag contains its ePC number in for example ROM shielded by ZAM authentication, we assume the tag has never been linked to the real identity of the owner and therefore would not reveal information beyond linkage to an anonymous (or even pseudonymous) transaction. From a security and privacy perspective the overall Zero-knowledge properties would still be strong as data linking would still be contained.

And even if the tag contains an ePC in ROM and the store transaction was linked to an identified consumer, we suggest that PRIVACY MODE still represents a strong protection of post-purchase privacy and security. Even if the zero-knowledge property would not be perfect.

Privacy Protection with Zero-Knowledge Device Authentication

Focussing on the Life Cycle, Phase 1 has no privacy threats, but as shown can have multiple security threats. ZAM might provide valuable security for this phase which should be investigated further.

From the analyses, it is clear that in Phase 2 prior to the User taking ownership of the Tag, the privacy and security Threats are not so much related to the RFID Tag itself, but more to the fact that the Tag adds information to the transaction which might be linkable to the consumer.

This is only a real privacy or security problem if the consumer is not protected by PET for authentication (including passive identification such as video cameras with face recognition), payments, communication etc.

Therefore if Security and Privacy are to be maintained when introducing Tags to the pervasive space, we must assume PET is implemented for the consumer. This includes, but is not limited to, Smartcards, Payments, Communication Devices and Surveillance (e.g. Cameras), which should all be designed with security and privacy in mind.

Assuming that consumers are not persistently identified a RFID tag in Phase 2 would be highly useful for customer service while maintaining privacy.

This would be beneficial for theft protection as product tags not paid for suddenly disappearing would signal attempted theft and only then would surveillance cameras or other theft protection be necessary. RFID could as such provide privacy-preserving or non-intrusive in-store theft protection.

In Phase 3 from Point-of-Sales to Recycling, the Tag turns into an active security and Privacy threat. By using devices with Zero Knowledge Device Authentication, these threats effectively blocked by creating an asymmetry between the consumer and other Actors such as the Retailer or infrastructure ensuring that the Tag.

When the consumer leaves the store, one of two scenarios may apply; either Total KILL or Privacy Mode:
1. Total KILL
   The consumer distrusts the technology entirely, is not able to digitally manage the authentication information or the tag does not support Privacy Mode. The store issues a total KILL command that ERASES all identifiers or physically remove/destroys the tag and in every aspect leaves the RFID-tag untraceable even when physically examined.
2. PRIVACY MODE
   The consumer takes active control of the product tag and prepares the product for intelligent linking within the consumer sphere such as for instance a shirt being prepared for the washing machine etc. When payment is ensured and authentication information has been transferred to the consumer, the store issues a TRANSFER⁵ command in order to enable PRIVACY MODE. The consumer leaves the store and may later use the received one-time-only authentication key to create a new key only known to the Product tag and the consumer.
      ⁵ Transferring control and establishing a new SSDK safe from retailer in-store eaves-dropping is not trivial. See the section of Key Management.

A third intermediate Passive PRIVACY MODE may be built-in for consumers that are not yet actively using the possibility to authenticate purchased products, but desire the ability to do so in the future⁶. This should be regarded as a temporary intermediate stage as an alternative to KILL in order to facilitate market change. The product tag will remain silent, but the consumer can at any time resume control of the Product tag and integrate the product within the consumer sphere. Until then the tag appear as if it is not there—perhaps for ever.
⁶ Passive PRIVACY MODE seems obvious for products requiring some sort of registration with the producer for service, firmware upgrades or products with home intelligence features or integration possibilities.

With PRIVACY MODE activated the consumer can make use of intelligent privacy-enhanced communication services including authenticating the RFID tag towards third-parties such as customer service or integrating the acquired product into an intelligent home environment.

RFID Product Lifecycle

| | Phase | | | |
|---|---|---|---|---|
| | I | II | | |
| | Supply | In- | III | IV |
| Tool | Chain | store | Post-Purchase | Re-cycling |
| RFID ePC Mode | + | !!/+ | !! | + |
| RFID Privacy Mode | | | + | |
| Consumer PET | | + | + | |

+ Fine
!! Don't
!!/+ Conditional

In Phase 3 a product with a Tag may change ownership several times.

In Privacy Mode, the previous Owner initiates a TRANSFER command in parallel with the change from Phase 2 to Phase 3.

When returning the product for recycling in Phase 4, consumer can disable PRIVACY MODE and restore the Tag to continue the original ePC mode in Phase 1,

Key Management

Transferring control requires that the Owner is able to manage the keys. The challenge is to balance usability and security as control transfers from the former Owner (e.g. Retailer) to the new Owner (e.g. the consumer).

One principle to follow is this:

The former Owner will transmit the ePC number and a related Ownership SSDK key to the New Owner in digital form to his Device such as a an anonymous PDA, a pseudonymous Privacy Authenticating Devices [3] or other PET Shopping Assistant Device implementing an Inventory Manager. If the session includes encryption this would prevent third-party eaves-dropping on the transfer.

The New Owner sends a TRANSFER command (for instance in the form of the combination of a ZAM message and <Transfer-code>+Hash(<Transfer>XOR RDK)) as a fourth parameter to the tag. By acknowledging transfer the tag verifies it has entered PRIVACY MODE and that all other keys including the ePC number are deleted in the tag. The new Owner then moves out of bounds from the former Owner and authenticates the tag with a change key⁷.
⁷ The main aspect here is that the New Owner can verify that the former Owner is not doing a man-in-the-middle based n the knowledge of the SSDK Ownership key and eaves-dropping on the Transfer ZAM message. This is another argument for including forward and backward secrecy.

Ownership SSDK keys are specific and not reused across multiple tags as these are not tamper-resistant. Multiple devices can coordinate key sharing and synchronize key changes using the Inventory management data within an Inventory domain such as a household sharing a Home Server.

But as mentioned the Ownership key could authenticate additional keys on the same tag depending on application purposes:

Group Authentication key with Segment Data: This would be highly useful for a washing machine which can use the same persistent SSDK for many tags. Critical for security of this simple application is that the response from the tag is not an identifier but rather category or segment data that would not distinguish the tag from a lot of other tags. Such a non-identifying response could be “Color Red, Max 60C”.

Group Authentication within Trusted environments:

For readers sharing the same inventory domain a natural question would be “Which tags are present?” without having to attempt authentication for each item in inventory. Application examples are household, or office applications.

For this purpose an additional Group Key shared between many tags is one solution. In order to prevent a physical intrusion in one tag making anyone able to access tags a two-step approach is suggested. First a Group key is used to get a tag-specific one-time-only reference which is then used by the Inventory manager who can maintain a reference table and translate the one-time-only reference into the specific tag. If necessary a second authentication can be carried out to authenticate the specific tag if more than identifying is relevant. New One-time-only references can either be added or generated from the Group RSK combined with the one-time-only reference being used. This is not trivial but is parallel to managing backward and forward secrecy of Ownership SSDK keys.

Group Authentication in Hostile environments:

When foreign readers should be able to access tags from different owners the Inventory Management approach is insufficient unless the same tag is accessed only once such as an event ticket. Multiple requests to the same tag would create linkability and tracking. Applications would include road tools, transport ticket machines, ecommerce shipping etc. These applications require additional identity management solutions and are as such outside the scope of this paper.

It should be noted here that even though the principles described in this paper would add to the security of commercial Tags, they are severely insufficient to solve the massive security problems related to for instance national passports with biometrics or National Id Cards which are presently suggested to be implemented without any security.

Resulting Security and Privacy Properties

This approach is based on the principle of designing the optimal security and privacy properties into the technology, with Security and Privacy in this understanding both related to the principle of Risk minimisation. Since no privacy threat is ever created, there is no need to regulate the use of data, no source of privacy-related distrust, no need for consent and no blackmail like trade-off decisions forced upon the consumer.

With Zero-knowledge Device Authentication RFID tags will remain silent until activated providing inherent protection against any unauthorised data collection. Even when activated the sessions will in most cases not reveal any information except when authenticated to respond for instance as part of a customer service session and even then linkage to a purchase is sufficient.

An attacker might not even know a two-party communication had occurred as the message can be broadcasted over a wide area and only the consumer knows what to expect as a response (e.g. a windows opens, a door unlocks—“is it activating the alarm, the heating being turned two degrees down or both”?). Each authenticated session is non-linkable to other sessions to anyone but the owner himself even in the case of persistent wiretapping incorporating all external parties working together

The protocol is highly useful for applications where the signal is relayed over open networks or other protocols. For instance this could implement a broadcast anti-theft control for a car using FM radio or other long-range radio signals which is picked up by for instance the car FM radio and relayed to toggle the built-in theft control which would initiate either a silent alarm, switch of the petrol or both. A key aspect here is that no tracking of the car is necessary until the car theft control itself starts to emit tracking signals.

Resulting Legal Properties

If the Tag is never linked to an identified or identifiable consumer and the Tag post-purchase remain in absolute consumer control there are no privacy or security threats to regulate.

Regulation could focus on the situations where security and privacy risks are created maliciously or though neglect, i.e. when RFID enter the store without consumer PET protection or when unsecured RFIDs are not removed at Point of Sales.

The main issue is to prevent the serious risk of unsecured RFID tags in public spaces. This approach prevents persistent device identifiers turning into person identifier or giving raise to any of a long array of security problems described independent of in-store consumer protection

Beyond all the obvious risks more advanced legal risks are avoided. For instance an ownership change in Phase 3 will avoid problems where an action of the New Owner through the ePC and the retail transaction is linked to the first Owner. The first Owner this way avoid reverse burden of proof. Similar, legally, change of Ownership does not lead to secondary use problems of the New Owner being associated with something related to the First Owner.

Another security threat to prevent is tracking or identification of individuals without absolute individual control Direct or indirect Identification should not take place without the individual active involvement. Otherwise the risks of Identity Theft and criminal abuse of fake identities are significant.

Resulting Business Value Properties

The key aspect of this approach is that it creates security without destroying business value for tags without Privacy Mode ability. Very cheap tags naturally are killed at Point of Sales without affecting their positive business value for the Supply Chain Management and in-store support. If the product is intended for post-purchase consumer applications, they can be equipped with RFID with Privacy Mode.

A key aspect is the perfect symmetry of consumer and retailer interests. If the tag is still responding when the consumer leaves the store one of two possibilities exists: 1) the consumer is stealing the product or 2) privacy mode was never activated. Either way an active tag will trigger store security. The Tags thereby present active theft protection and at the same time reduce the need for secondary surveillance. This means that the proposed model does not interfere with the common use of RFID tags as active theft protection.

If the product was properly purchased but the tag is still responding either the store made an error or the tag is not respecting basic privacy requirements. The consequence is either the store or the producer is guilty of attempted privacy violation. Since the consumer can check this using any RFID reader and bounty bonuses can be applied, privacy violations are rapidly detected and stopped. The tag thereby creates protection against privacy violations.

A particular interesting aspect of this approach is the open road to implementation. Since the RFID is dual-mode, current RFID standards can be supported at the same time as new Privacy Mode enabled RFID tags are introduced.

Another aspect is the potential for unsynchronised implementation of active tags and consumer Tag handling devices. Even if the consumer is not able to make use of the Tag when the product is purchased, he can later acquire that ability and make use of the built-in tags

The consumer can release linkable information to get convenience and services if the retailer or other service provider makes this valuable to him. If the consumer wants Post-purchase RFID support of his property that was originally equipped with a non-secured tag, he can attach his own RFIDs with Privacy Mode without any reduction in functionality and even link this back to the transaction and original ePC number if the retailer or producer is able to support this step. If he wants to he can even instruct the RFID tag to remain in ePC mode even though this would in most cases be a bad idea compared to implementing some sort of specific key.

In short, it is difficult to see what kind of business value is lost. But the causes of privacy and security concern are removed reducing the barriers for RFID take-up and the tag can remain usable for customer service and Home intelligence Post-purchase without creating security threats.

Attack Analysis

In order to analyse the privacy properties of the proposed mechanism, we consider the commonly used Dolev & Yao model, where an attacker has the following properties:
1. the attacker can obtain/decompose any message sent over the network (in this case any message exchanged between RFID reader and tag);
2. the attacker can remember/insert messages using messages that have already seen;
3. the attacker can initiate communication with either tag or reader;
4. given the key, the attacker can encrypt/decrypt all messages;
5. the attacker cannot get partial information, guess the key or perform statistical analysis; and
6. without the key, the attacker can neither alter nor read encrypted messages.

For the purpose of this analysis, we assume that the attacker cannot interfere with the physical artefacts in the system (RFID tags and readers) or with the backend system. However, we do expect the attacker to attempt to masquerade as one of the physical artefacts.

Attacking RFID Tags

Attacks where the attacker masquerades as a valid reader.

This kind of attack is defeated by the shared secret because the tag does not recognise valid readers per se, but only readers able to present a valid authentication requests.

Care should be given to designing the messages in specific applications to minimize the ability to learn from the message size and especially not ignoring that the setup assumes relaying.

Attacking RFID Readers

Attacks where the attacker masquerades as a valid tag.

This kind if attack is defeated by the shared secret because the Actor does not identify the tag, but only recognise that the tag is able to decrypt the authentication message and respond accordingly.

Attacking the Communication Between Tags and Readers

Eavesdropping on a single session is not providing information because communication is encrypted and zero-knowledge.

Modification attacks, where the attacker interferes with the communication by changing elements—results in a Denial of Service as all three elements of the ZAM protocol are linked and one part cannot be changed without making the tag ignore the authentication request as invalid.

Only successful authentication will result in Tag activation creating a change in the tag (updating the last successful DT, potentially changing the SSDK and initiating a session mode according to the specific application). The ZAM protocol in itself protects against replay attacks. Attempts to overload the Tag by external Distributed Denial of service attacks should not produce any serious problem as Tags naturally discard non-verifiable authentication requests without responding. The tag automatically resets when the induced power is insufficient to operate.

4) Man-in-the-Middle attacks.

These are defeated since the authentication procedure require the Actor to initiate the authentication protocol. Multiple applications would actually benefit by the fact that the protocol can work from a distance assuming “man-in-the-middle” relaying the authentication protocol for instance in Key toggling modes.

The setup is transparent to man-in-the-middle as responses are also zero-knowledge. An attacker can through direct reading learn that a present device and a present RFID tag communicate, but he cannot learn an identifier of either device. Masquerading requires access or brute force guessing the shared secret SSDK.

5) Brute-force attack on session key and shared secret

An attacker can record the authentication and attempt to do offline brute-force attack. Notice that even guessing the correct Random Session Key (RSK) does not provide access to the shared secret SSDK. The attacker would not even be able to verify that he had guessed the Random Session key.

We have not analysed the optimal brute-force attack approach, but expect that this would be to run through combinations of RSK and SSDK and trying to verify the authentication request. This should be sufficient for all applications where RFIDs is a likely choice as key size can be chosen accordingly.

High-value or sensitive applications would either move to device with more computational power or ensure damage control for instance so that an attacker would not have time to do a brute-force attack on the session before the keys have changed.

However a successful brute-force attack on a reused Shared Secret would potentially make the attacker able to take over control of the tag. Damage control against this attack would likely incorporate changing the shared secret on a per session basis.

Changing keys with backward secrecy can be implemented by changing the shared secret SSDK on a per session basis using the Random Session Key in a combination with a hashing or other non-reversible algorithm. To ensure forward secrecy for sensitive application this is best implemented as a social procedure by changing the SSDK in different locations. The attacker only needs to miss one session to loose the ability to use a key broken by brute force to gain control of the tag.

A combination of eaves-dropping and using the knowledge of the original keys can be defeated through changing the SSDK outside the reach of the eaves-dropper. This would also apply to attacks incorporating physically inspecting the keys while leaving the tag intact.

Using the Retailer knowledge of the original key to track a Tag in Passive Privacy Mode can be made detectable by making the original key a one-time-only key requiring change on first use.

Attacks Including Interference with the Physical Artefacts

The attacker can physically get access to the keys in the Tag

Damage control can be incorporated by removing any external keys and using the SSID as an intermediate tag Identifier. SSDK should NOT be reused across multiple Tags. A combination of a Physical Attack and eaves-dropping is unlikely but would be highly effective. The main protection against this kind of attack is by changing the keys outside the eaves-droppers reach

A more advanced and serious attack model is where RFID producers of the original Tags incorporate a hidden backdoor. Since the same protocol described here can be used to create sleeping agents that can only be activated by those with access to the shared SSDK key provided by the producer, the only way to detect this privacy/security threat is through physical inspection.

When the violation occurs it is difficult to detect as even then the protocol is zero-knowledge and the only detectable aspect is that the Tags apparently responded to some undetermined request. This attack incorporating tracking or additional functionality would be difficult to detect in specific attacks targeted at a specific consumer similar to any attack incorporating huge resources and faked products with backdoors.

What is important is that such an attack would be highly vulnerable to physical inspection of the RFID tags as they are not tamper-resistant. For commercial approaches this seems unrealistic as the risk and consequences of exposure would be out of proportion with the business value in normal context. For government to do generic tracking this would require the use of the same key in all devices and thereby building in both vulnerabilities and risk of detection.

Related Work

Two approaches have been proposed to address the privacy concerns in RFID systems: Legislation (data protection laws) and technology (privacy enhancing technologies).

Legal Framework

There is much consideration on how to regulate the RFID space to prevent the strongly privacy invasive aspects of RFID. Two main approaches have been considered—KILL and Policy-based approaches.

Much consideration focuses on deactivating the RFID tag either physically or by issuing a KILL command. However, this prevents the use of RFID tags for other purposes, such as warranty, authenticity, return of goods, use of presents with purchase information attached and home intelligent applications, i.e., second and third phase of the RFID tag life cycle. Moreover, the KILL approach is not usable in many situations such as proximity use in toll booths, tickets, access etc.

Another approach is to inform consumers about the embedded RFID tags, in order to make the privacy violation acceptable. However, this approach will often turn into an advanced form of blackmail where consumers have the impossible choice of not getting a service or accepting a service designed using privacy-invasive principles.

Using this approach it can be shown that the entire shopping process can be fully anonymous EVEN with self-service shopping. Since no collection of identifiable personal data takes place, a perfect balance between consumer convenience and the shop desire for supply chain efficiency and customer relationship support can be established.

The outcome is that the only need for legal regulation is to handle the situations where RFIDs still respond post-purchase. This translates into one of two scenarios; either the product is being stolen and doors can close and surveillance cameras be activated OR either the shop or one of the suppliers have integrated non-privacy respecting RFIDs into the product in which case this translates into a violation of consumer privacy.

In other words RFIDs responding post-purchase should in any case translate into an offence. Legal regulations can simply state that if anyone is able to pick up an unauthenticated signal from a RFID there is a legal violation.

Privacy Enhancing Technologies

Ari Juels [4] suggest a key change protocol based on a double hash focussing on backward secrecy. This approach is not implementing consumer privacy towards the infrastructure as the key is suggested to have a direct translation to the ePC key framework. Moreover, this approach has significant problems related to key synchronisation, as each request will result in a secret key change.

In another paper [16], Ari Juels proposes various approaches to protect the RFID tag which may be embedded in EURO-notes using participants as trusted parties to re-encrypt the information stored in the RFID tag. This approach both leaks information and requires the constructive participation of entities that may prefer to jam the trace process.

Stephen Weis [12, 13] suggests a protocol where a consistent shared secret key is shielded using a random key generated by the RFID itself and authentication requires transmission of the shared secret itself. This approach will require comprehensive searches and as soon as the shared secret is transmitted in the open the RFID will be have no backward secrecy.

Engberg & Harning [3] show how a reverse authentication towards infrastructure can be used to establish location privacy in wireless environments using a modified mobile communicating device called a Privacy Authenticating Device. This principle turns wireless devices into session-only linkable transaction which combined with an RFID reader can be shown to create the basis of a privacy infrastructure support for in-store active RFID tags that has not yet entered privacy Mode.

Inoue et al. [17] suggest a basic solution where a shared secret makes the RFID remain silent hiding the persistent key. This approach contains no authentication mechanism or suggestions on how to work in real-world settings.

Other approaches can be based on the blocker tags where the consumer carries a special protection tag responding to confuse any reader and hide the real tags carried. As a general rule it is wrong leaving it to the consumer to try protecting himself from a bad technology design. In addition this approach requires the protection device to be able to protect against any protocol in any frequency jamming the actual response which must be considered a highly vulnerable and risky approach.

Future Work

The main activity we would like to look into is a detailed crypto analysis to determine the ZAM protocol resistance to especially brute force and various other attacks.

The current system relies on a permanent shared secret between the RFID reader and tag, which may introduce problems. However, we believe that the random session key can be shown to provide a good basis for changing the shared secret SSDK on a per session basis, which will provide backward secrecy (using for instance a hash combination) and forward secrecy (an attacker needs to record every change as there is no algorithmic link between the various SSDK). Synchronisation of changing shared secrets can be established based on the acknowledgment as the coordinating mechanism. This is easier because the Random Session key is chosen by the Actor. We would like to further develop the protocol to incorporate these ideas.

We have focused on zero-knowledge securing seriously resource constrained devices in this paper. However, the principles presented in this paper can easily be shown to port to stronger asymmetric encryption as well as most protocols and devices.

It is important to develop handover protocols for the point of purchase, which will minimise the risk of future man-in-the-middle attacks by previous owners. We would like to explore solutions based on intelligent agents that help automate the handover process and increases convenience for the consumer.

We wish to explore how the proposed protocol can securely be extended into a group authentication protocol within a trusted infrastructure, such as home intelligence or certain workplace intelligence applications, using one-time-only identifiers.

One of the advantages of the proposed protocol, compared to other privacy enhancing technologies proposed for RFID systems, is however that it does not require a trusted infrastructure. We therefore believe that this protocol can securely extend into a group authentication protocol within an untrusted infrastructure, such as car road tolls, event tickets etc. using a combination of one-time-only identifiers and consumers identity PETs. This would allow an advanced anonymous implementation with authentication to authorize the release of centrality stored tickets and still ensuring instant revocability in case of theft etc. Finally, development of a group authentication protocol should make it possible to add new one-time-only references dynamically over open channels.

An important area to look deeper into is the problem were seemingly mutually excluding security needs meet such as for instance Product Authenticity vs. Owner Control, Anti-money laundering vs. Data Protection or even worse Digital Rights vs. Consumer Fair Use and the serious problem of Trusted Computing vs. Freedom. Product Authenticity can be solved to a satisfying level by ensuring consumer ability to demonstrate a purchase—but making this required would create reverse burden of proof so that inability to demonstrate purchase and product authenticity is proof of theft.

This leads to the generic discussion of free consumer choice at Point of Sales directing market development. The question of maintaining a RFID tag without security makes little sense as the consumer has likely no idea of the potential consequences, cannot detect or see the data collection, have unclear causal understanding between the collection of data and the abuse potential, have little impact as the real decision is dependant on a long supply chain that is really controlled by industry standards and finally the consumer can easily be faced with a deliberate unbalanced choice of accepting an undeterminable threat compared to loosing real services such as warranty, intelligence or upgrades. Due to this we suggest that this discussion will be very difficult to leave to the consumer choice at point of sales as it would become a destructive debate between consumer rights organizations and industry rather than a question of individual choice directing market trends.

Behind this is an even more fundamental question for market theorists on how market dynamics work in a digital world, for socio/economics on how people behave and make decisions, for technicians on how to design technology with security and privacy incorporated, questions for industry on how to ensure that real market demand is feed back into the standards and design processes, to marketers on the logic in building barriers between the company and customers and of course regulatory questions for politicians on what all this means for policy. We need better balances both within and between all these areas. If not we risk damaging the market forces and the very fundamentals of prosperity, stability and quality of life.

### CONCLUSION

RFID tags without security used for consumer applications incorporate serious risk of abuse for commercial, political, social or criminal purposes. But especially the risk of identity theft of passive proximity tags, tracking or targeting devices could easily lead to serious breaches of security and privacy.

From the analysis in this paper we conclude that incorporating PETs in the RFID tag would not only solve the RFID Security and Privacy problems but it would do so without reducing the obvious value for process efficiency, customer service, recycling and also security purposes such as theft protection.

We conclude that Zero-Knowledge Device Authentication would provide such a PET solution as a general solution for resource constrained devices in the ambient space and RFID in particular.

The attack analysis shows that even though the computational resources are scarce, the solution is highly resistible to realistic attacks. Also there are additions that would make this approach resisting even resourceful attacks or implement operational damage control even in the case of physical intrusion to access keys in the RFID tag.

We suggest that even though there are strong reasons to require KILL of RFIDs without security at Point-of-Sales this should not apply to RFID redesigned to meet security and privacy requirements for consumer applications.

We conclude that the in-store privacy problem is not related to RFID per se but that RFID used in-store is escalating existing security and privacy problems related to lack of attention to Consumer PETs for payments, communication and security purposes. We suggest that further attention should be given to the question of in-store consumer PETs.

From the analysis it is also clear that many present commercial applications for the consumer space lack even basic security properties and are open to a multitude of abuse attacks. Without discussing this in further detail, we have indicated generic ways to solve most of these problems using a combination of Zero Knowledge Device Authentication, Group Authentication, one-time-only identifiers, intelligent linking of surveillance equipment with PET solutions and privacy enhanced Identity management integrated in infrastructure.

We consider it highly likely that most applications such as ID cards, communication, payments, car tolls, ticketing, access control, libraries, home intelligence, mobile intelligence etc. can be technically designed or redesigned to incorporate basic security and privacy requirements. If industry will not do it themselves and consumers can not do it through the market, then other means should be considered.

We suggest that we can and should make Privacy Default, i.e. preserve individual ownership and control of personal data. What we set out to show in this paper was that in the area of RFID this does NOT lead to loss of business value—on the contrary, balanced security and privacy might eliminate critical barriers to economic growth by ensuring end-user control and eliminate sources of risk and distrust.

### REFERENCES

[1] Auto-ID Center, Consumer Privacy Concerns—http://www-mmd.eng.cam.ac.uk/automation/w_papers/cam-autoid-eb002.pdf—(Auto-ID Center moved—link checked May 2004)
[2] Convenience Triumphs Privacy-http://www.cio.com/archive/092203/saffo.html
[3] ENGBERG, S., HARNING, M, Privacy Authentication—Persistent Non-identification in Ubiquitous Environments, Workshop on Socially-informed Design of Privacy-enhancing Solutions in Ubiquitous Computing, at UbiComp2002, Gothenburg, September 2002, http://www.obivision.com/papers/privacyauthentication.pdf (checked Jan. 17, 2004).
[4] JUELS, A., Privacy and Authentication in Low-Cost RFID Tags, In submission 2003, http://www.rsasecurity.com/rsalabs/staff/bios/ajuels/publications/pt-rfid/index.html
[5] Gillette/Tesco Case—http://www.outlaw.com/php/page .php?page_id=tescousingrfidtag 1059647038&area=news
[6] Privacy Conference 2003, Privacy Commissioners resolution on RFID, http://www.privacyconference2003.org/resolutions/res5. DOC
[7] YOSHIDA, J., Euro bank notes to embed RFID chips by 2005, EE Times, Dec. 19, 2001, http://www.eetimes.com/story/OEG20011219S0016 (checked Jan. 17, 2004).
[8] SAP AG: Adaptive Supply Chain Networks, SAP White Paper, 2002.
[9] QUINN, F. J., The Payoff Potential in Supply Chain Management, ASCET: Achieving Supply Chain Excellence through Technology, 1999, http://quinn.ascet.com (checked Jan. 17, 2004).
[10] RFID in customer cards: Test is discontinued, 2004, http://www.future-store.org/servlet/PB/menu/1002376_I2/index.html
[11] Benetton Explains RFID Privacy Flap, RFID Journal, Jun. 23, 2003, http://www.rfidjournal.com/article/articleview/471/1/1/
[12] WEIS, S. A., Security and Privacy in Radio-Frequency Identification Devices, M.Sc. Dissertation, M.I.T., May 2003.
[13] Weis, S. A., Sarma S. E., Rivest, R. L., Engels D. W., Security and Privacy Aspects of Low-Cost Radio Frequency Identification Systems, 1^{st} Annual Conference on Security in Pervasive Computing, Boppard, Germany, March, 2003.
[14] Engberg, Stephan, 2002, EU-IST workshop Living with Security, Privacy through Virtual Identities in Infrastructure, http://www.obivision.com/Papers/IST_Living_with_security_{—}20021106.PDF
[15] Bowen seeks balance in RFID law, 2004, http://www.rfidjournal.com/article/articleview/812/1/1/
[16] Juels, A., Pappu, R., Squealing Euros: Privacy Protection in RFID-Enabled Banknotes, Seventh International Financial Cryptography Conference, Gosier, Guadeloupe, January 2003.
[17] Inoue, S., Konomi S., Yasuura., Privacy in Digitally Named World with RFID Tags, Workshop on Socially-informed Design of Privacy-enhancing Solutions in Ubiquitous Computing, at UbiComp2002, Gothenburg, September 2002.
[18] Brock, D., The Electronic Product Code (ePC)—A Naming Scheme For Physical Objects, White Paper MIT-AUTOID-WH002, Auto-ID Center, January 2001.
[19] Brock, D., The Compact Electronic Product Code—A 64-Bit Representation of the Electronic Product Code, White Paper MIT-AUTOID-WH008, Auto-ID Center, November 2001.
[20] Engels, D., ePC-256: The 256-bit Electronic Product Code™ Representation, Technical Report MIT-AUTOID-TR010, Auto-ID Center, February 2003.
[21] Dolev, D., Yao, A., On the Security of Public Key Protocols, IEEE Trans. on Information Theory, 29(2), (1983) 198-208.
[22] EU Smarttags Workshop, Bruxelles 2004, Final Report http://www.cordis.lu/ist/directorate_d/ebusiness/workshop.htm
[23] Demos, The Future of Privacy, 1998.

1. A method of establishing a communication path from a first legal entity in a data communication network, comprising the steps of:
providing at least one private reference point comprised in said data communication network,
establishing a communication path from said first legal entity to said private reference point,
verifying the authentication of said first legal entity relative to said private reference point from said first legal entity and
establishing communication from said private reference point to a second legal entity through said data communication network without disclosing the identity of said first legal entity.

2. The method according to claim 1, further comprising a preliminary step of authenticating said first legal entity by registering data selected from the group consisting of biometrics, a signature, a code and any combinations thereof and comparing the registered data with correspondingly stored data.

3. The method according to claim 1 or 2, said first legal entity being an identity device.

4. The method according to claim 1 or 2, wherein said first legal entity comprises a card including encrypted data, said method further comprising:
said first legal entity receiving an encrypted key from said private reference point,
decrypting said encrypted key using a second stored key, and
decrypting said encrypted data using said key.

5. The method according to claim 1 or 2, said communication network being selected from the group consisting of a personal area network, local area network, a wide area network, a global area network, the Internet, a radio network, a PSTN, a GSM network, a CDMA network, a UMTS network and any combinations thereof.

6. The method according to claim 1 or 2, said private reference point being addressable by the authenticated holder of said first legal entity from a computer communicating with said data communication network.

7. The method according to claim 1 or 2, further comprising said first legal entity allowing or blocking access to said private reference point by a third legal entity.

8. The method according to claim 7, wherein said third legal entity is a party selected from the group consisting of a third party and said first legal entity.

9. The method according to claim 1 or 2, wherein said communication involves creating and negotiating an accountability path for this otherwise anonymous transaction dynamically adapted to the context risk profile.

10. The method according to claim 9, wherein said second legal entity establishes a procedure to identify a party selected from the group consisting of said first legal entity and the holder of said first legal entity.

11. The method according to claim 1 or 2, wherein said specific identification information is selected from the group consisting of at least one of biometrics, name, digital signature, and a code.

12. The method according to claim 1 or 2, further comprising:
providing an identity provider and a service provider,
establishing communication from said second legal entity to said service provider,
establishing communication from said service provider to said identity provider,
providing a fifth legal entity, constituted by a financial institution,
establishing communication from said service provider to said fourth legal entity,
transmitting information from said second legal entity to said service provider,
transmitting said information from said service provider to said identity provider,
transmitting said information from said identity provider to said fifth legal entity,
said fourth legal entity responding to said information by transmitting an payment accept to said identity provider,
said identity provider transmitting payment accept to said service provider, and
said service provider transmitting payment accept to said second legal entity.

13. A system for establishing a communication path from a first legal entity in a data communication network, comprising:
at least one private reference point comprised in said data communication network,
a communication path defined from said first legal entity to said private reference point,
the authentication of said first legal entity being verified relative to said private reference point from said first legal entity and
a path of communication established from said private reference point to a second legal entity through said data communication network without disclosing the identity of said first legal entity to said second legal entity.

14. The system according to claim 13, wherein said private reference point is stored on a server communicating with said data communication network.

15. The system according to claim 13 or 14, wherein said communication network is selected from the group consisting of a personal area network, a local area network, a wide area network, a radio network, a global area network, the Internet, a PSTN, a GSM network, a CDMA network, a UMTS network and any combinations thereof.

16. The system according to claim 13 or 14, wherein said first legal entity is an identity device.

17. The system according claim 13 or 14, wherein said first legal entity comprises a card including encrypted data for verifying the authenticity relative to said private reference point.

18. The system according to claim 13 or 14, wherein said authenticity of said first legal entity is obtained by use of data selected from the group consisting of at least one of biometrics and codes and digital signatures.

19. (canceled)
